(19) United States
(12) Patent Application Publication
(10) Pub. No.: US 2025/0390975 A1
(43) Pub. Date: Dec. 25, 2025

(54) POINT CLOUD PROCESSING METHOD, IMAGE SIGNAL PROCESSOR, RADAR CHIP AND LIDAR

(71) Applicant: SUTENG INNOVATION TECHNOLOGY CO., LTD., Shenzhen (CN)

(72) Inventors: Renfang HUANG, Shenzhen (CN); Yumin LIAO, Shenzhen (CN)

(73) Assignee: SUTENG INNOVATION TECHNOLOGY CO., LTD., Shenzhen (CN)

(21) Appl. No.: 19/241,339

(22) Filed: Jun. 17, 2025

(30) Foreign Application Priority Data
Jun. 20, 2024 (CN) 202410807972.5

(51) Int. Cl. G06T 1/20

(52) U.S. Cl. CPC G06T 1/20

(57) ABSTRACT

A point cloud processing method, an image signal processor, a radar chip, and a LiDAR are provided. The point cloud processing method is applied to an image signal processor. The point cloud processing method is configured to run multi-level algorithms for point cloud processing. The multi-level algorithms include a first-level algorithm, a second-level algorithm, and a third-level algorithm that share a buffer space. The method includes: obtaining original point cloud data; starting the first-level algorithm to process the original point cloud data to obtain first point cloud data, and buffering the first point cloud data in a buffer space; and according to a delay difference between the second-level algorithm and the third-level algorithm, simultaneously inputting at least part of the first point cloud data and the second point cloud data into the third-level algorithm.

### CROSS-REFERENCE TO RELATED APPLICATION

The present application claims the benefit of priority to Chinese Patent Application No. 202410807972.5, filed on Jun. 20, 2024, which is hereby incorporated by reference in its entirety.

### TECHNICAL FIELD

The present application relates to the field of laser detection technology, and in particular to a point cloud processing method, an image signal processor, a radar chip, and a LiDAR.

### BACKGROUND

The image signal processor (ISP) is typically set within the LiDAR chip to receive and process the raw point cloud data obtained by the photodetector (PD).

At present, image signal processors usually adopt multi-level algorithms to process raw point cloud data, and each algorithm level is implemented as a serial data stream processing structure. That is, the preceding algorithm module stores the processed results into the buffer space of the subsequent algorithm module, and the subsequent algorithm module reads the data from its buffer space, and then performs the corresponding processing.

In the process of implementing the present application, it was found that there are at least the following problems in the prior art: the existing image signal processor utilizing multi-level algorithms is a sequential stream processing structure, and its total delay is the sum of the accumulated delays of each algorithm module at each level, resulting in a relatively high overall delay of the image signal processor. Furthermore, since each level of the algorithm module corresponds to a dedicated buffer space, the area of the chip is increased, resulting in greater power consumption by the chip.

### SUMMARY

The embodiments of the present application provide a point cloud processing method, an image signal processor, a radar chip, and a LiDAR, each of which reduces the overall delay of the image signal processor and reduce the power consumption of the chip.

The embodiments of the present application provide the following technical solutions.

In a first aspect, an embodiment of the present application provides a point cloud processing method, which is applied to an image signal processor, and the image signal processor is configured to run multi-level algorithms for point cloud processing, and the multi-level algorithms include a first-level algorithm, a second-level algorithm, and a third-level algorithm, where the first-level algorithm, the second-level algorithm, and the third-level algorithm share a buffer space, and the point cloud processing method includes:
obtaining original point cloud data;
starting the first-level algorithm to process the original point cloud data to obtain first point cloud data, and buffering the first point cloud data in the buffer space; and
according to a delay difference between the second-level algorithm and the third-level algorithm, simultaneously inputting at least part of the first point cloud data and the second point cloud data into the third-level algorithm, where the second-level algorithm is configured to process the obtained first point cloud data to obtain second point cloud data, the third-level algorithm is configured to process the obtained first point cloud data to obtain third point cloud data, and merge the second point cloud data and the third point cloud data to output the merged result.

In a second aspect, an embodiment of the present application provides an image signal processor, which applies the point cloud processing method of the first aspect, and the image signal processor includes a multi-level algorithm module, the multi-level algorithm module includes a first-level algorithm module, a second-level algorithm module, and a third-level algorithm module, where the first-level algorithm module, the second-level algorithm module, and the third-level algorithm module share a buffer space; the first-level algorithm module is connected to the second-level algorithm module and the third-level algorithm module, and is configured to obtain original point cloud data, and start the first-level algorithm to process the original point cloud data to obtain first point cloud data, and the first point cloud data is buffered in the buffer space; the second-level algorithm module is connected to the first-level algorithm module and the third-level algorithm module, and is configured to obtain at least part of the first point cloud data in the buffer space, and perform the second-level algorithm processing on the obtained first point cloud data to obtain second point cloud data; the third-level algorithm module is connected to the first-level algorithm module and the second-level algorithm module, and is configured to simultaneously obtain at least part of the first point cloud data and the second point cloud data, and perform the third-level algorithm processing on the obtained first point cloud data to obtain third point cloud data, and merge the obtained second point cloud data and the third point cloud data to output the merged result.

In a third aspect, an embodiment of the present application provides a radar chip, the radar chip includes:
a processor and a memory, the processor is configured to execute the executable program code in the memory, and when the executable program code is executed, the processor executes instructions of the point cloud processing method in the first aspect; or
such as the image signal processor in the second aspect.

In a fourth aspect, an embodiment of the present application further provides a LiDAR, the LiDAR includes:
such as the radar chip in the third aspect.

In a fifth aspect, an embodiment of the present application provides a non-volatile computer-readable storage medium, which stores computer-executable instructions. When the computer-executable instructions are executed by a processor, the processor executes the point cloud processing method as in the first aspect.

The beneficial effect of the present application is that, different from the prior art, the present application provides a point cloud processing method applied to an image signal processor configured to run multi-level algorithms for point cloud processing, the multi-level algorithms including a first-level algorithm, a second-level algorithm, and a third-level algorithm, where the first-level algorithm, the second-level algorithm, and the third-level algorithm share a buffer space. The point cloud processing method includes: obtaining original point cloud data; starting the first-level algorithm to process the original point cloud data to obtain first point cloud data, and buffering the first point cloud data in the buffer space; according to a delay difference between the second-level algorithm and the third-level algorithm, simultaneously inputting at least part of the first point cloud data and the second point cloud data into the third-level algorithm, where the second-level algorithm is configured to process the obtained first point cloud data to obtain second point cloud data, and the third-level algorithm is configured to process the obtained first point cloud data to obtain third point cloud data, and merge the second point cloud data and the third point cloud data to output the merged result.

On the one hand, because the first-level algorithm, the second-level algorithm, and the third-level algorithm share a buffer space, the present application only needs to set up one buffer space, and there is no need to set up a buffer space for each level of the algorithm, which can reduce the area of the chip and thus reduce the power consumption of the chip. On the other hand, according to the delay difference between the second-level algorithm and the third-level algorithm, the second point cloud data processed by the second-level algorithm and the first point cloud data read from a buffer space are simultaneously input into the third-level algorithm, the technical solution provided by the present application can reduce the delay of waiting for the processing result of the second-level algorithm, thereby reducing the overall delay of the image signal processor.

### BRIEF DESCRIPTION OF DRAWINGS

One or more embodiments are exemplarily described with reference to the figures in the corresponding drawings, and these exemplary descriptions do not constitute limitations on the embodiments. Elements with the same reference numerals in the drawings represent similar elements, and unless otherwise stated, the figures in the drawings do not constitute limitations as to scale or proportion.

FIG. 1 is a serial data stream processing structure disclosed in an embodiment of the present application;

FIG. 2 is a schematic diagram of a parallel data stream processing structure disclosed in an embodiment of the present application;

FIG. 3 is a schematic diagram of a flow diagram of a point cloud processing method disclosed in an embodiment of the present application;

FIG. 4 is a schematic diagram of a detailed flow diagram of step S303 in FIG. 3;

FIG. 5 is a schematic diagram of a detailed flow diagram of step S332 in FIG. 4;

FIG. 6 is a schematic diagram of the first sliding window and the second sliding window obtaining corresponding window data from a buffer space disclosed in an embodiment of the present application;

FIG. 7 is a schematic diagram of an output timing of the first window data and the second window data disclosed in an embodiment of the present application;

FIG. 8 is a schematic diagram of a flow diagram of reading the first point cloud data in a buffer space through a sliding window when the number of lines in the sliding window is one line, disclosed in an embodiment of the present application;

FIG. 9 is a schematic diagram of a buffer space storing the first point cloud data disclosed in an embodiment of the present application;

FIG. 10 is a schematic diagram of a flow diagram of reading the first point cloud data in a buffer space through a sliding window when the number of lines in the sliding window is multiple lines, disclosed in an embodiment of the present application;

FIG. 11 is a schematic diagram of a detailed flow diagram of step S1003 in FIG. 10;

FIG. 12 is a schematic diagram of a detailed flow diagram of step S1004 in FIG. 10;

FIG. 13 is a schematic diagram of a detailed flow diagram of step S1005 in FIG. 10;

FIG. 14 is a schematic diagram of the first sliding window and the second sliding window obtain corresponding window data from a buffer space disclosed in an embodiment of the present application;

FIG. 15 is a schematic diagram of the first sliding window and the second sliding window obtain corresponding window data from a buffer space disclosed in an embodiment of the present application;

FIG. 16 is a schematic diagram of the structure of an image signal processor disclosed in an embodiment of the present application;

FIG. 17 is a schematic diagram of the relationship between a buffer space, the first window taking module and the second window taking module disclosed in an embodiment of the present application;

FIG. 18 is a schematic diagram of the structure of a radar chip disclosed in an embodiment of the present application;

FIG. 19 is a schematic diagram of the structure of a radar chip disclosed in an embodiment of the present application; and

FIG. 20 is a schematic diagram of the structure of a LiDAR disclosed in an embodiment of the present application.

Reference signs: 160, image signal processor; 1601, multi-level algorithm module; 1611, first-level algorithm module; 1612, second-level algorithm module; 1613, third-level algorithm module; 180, radar chip; 181, processor; 182, memory; 161, buffer space; 200, LiDAR; 162, digital signal processor.

### DETAILED DESCRIPTION

In order to achieve the objectives, technical solutions, and advantages of the present application clearer, the present application is further described in detail in conjunction with the accompanying drawings and embodiments. It should be understood that the specific embodiments described herein are provided solely for the purpose of illustrating the present application and are not intended to limit the present application in any way.

It should be noted that, when there is no conflict, various features described in the embodiments of the present application can be combined with each other, and all such combinations are within the protection scope of the present application. In addition, although the functional modules are divided in the device schematic diagram and the logical sequence is shown in the flow diagram, in some cases, the steps shown or described herein can be performed in a sequence different from the module division in the device or the sequence in the flow diagram. Furthermore, terms such as “first,” “second,” and “third” as used in the present application do not limit the data or the execution order, but only used to distinguish between identical or similar items having substantially the same functions and effects.

The technical solution of the present application is described in detail below with reference to the accompanying drawings.

The image signal processor (ISP) is typically set within the LiDAR chip to receive and process the raw point cloud data obtained by the photodetector (PD). At present, the image signal processor usually adopts multi-level algorithms to process the raw point cloud data, and each algorithm level is implemented as a serial data stream processing structure.

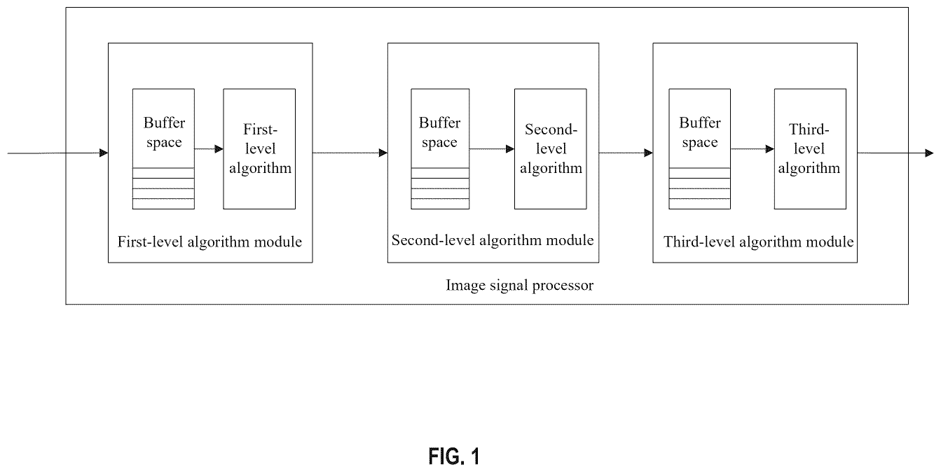

In an embodiment, please refer to FIG. 1, which is a serial data stream processing structure disclosed in an embodiment of the present application.

As shown in FIG. 1, each level of algorithm module corresponds to a dedicated buffer space. The preceding algorithm module stores the processed results into the buffer space of the subsequent algorithm module. The subsequent algorithm module then reads data from its buffer space, and then performs corresponding processing for that level.

In an embodiment, when the window data obtained by the first-level algorithm module is 15 lines of point cloud data, the window data obtained by the second-level algorithm module is 3 lines of point cloud data, and the window data obtained by the third-level algorithm module is 9 lines of point cloud data, the buffer space required by the first-level algorithm is at least 15 lines. When the latter two level algorithms adopt the online windowing method to reduce the delay, the buffer space required by each of the latter two level algorithm modules is at least the total number of lines of the corresponding sliding window−1, and the three level algorithm modules need at least 15+2+8 lines of buffer space in total. Since each level of the algorithm module corresponds to a dedicated buffer space, the area of the radar chip is increased, resulting in an increase in power consumption of the radar chip.

In the serial data stream processing structure, the total delay is the sum of the accumulated delays of each algorithm module at each level, which will result in a higher overall delay of the image signal processor.

Based on this, an embodiment of the present application provides a point cloud processing method to reduce the overall delay of an image signal processor and reduce the power consumption of a radar chip. The point cloud processing method is applied to an image signal processor that adopts a parallel data stream processing structure.

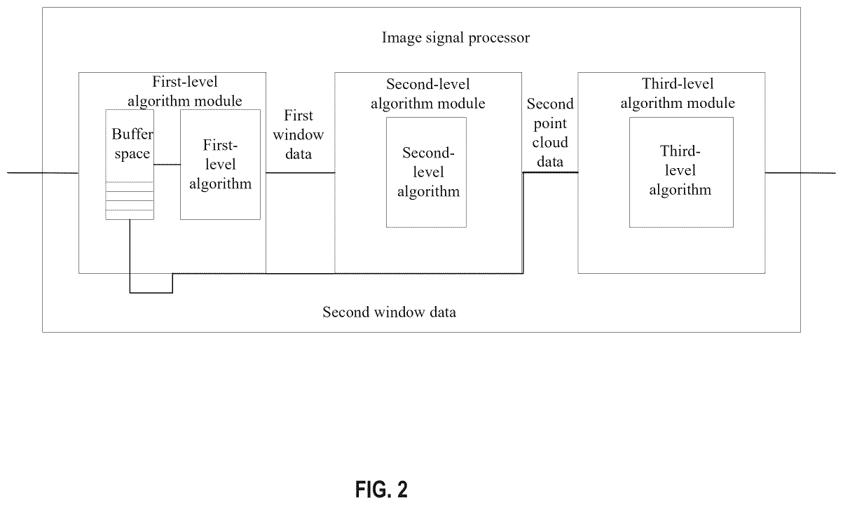

Refer to FIG. 2, which is a schematic diagram of a parallel data stream processing structure disclosed in an embodiment of the present application.

FIG. 2 takes the correspondence between the buffer space and the first-level algorithm as an example for explanation. In some embodiments of the present application, when the buffer space is set in the image signal processor, the buffer space can be set in the module where the first-level algorithm is located, or it can be set outside the module where the multi-level algorithms are located. In some embodiments of the present application, the buffer space can be set within the radar chip and outside the image signal processor.

As shown in FIG. 2, the first-level algorithm, the second-level algorithm, and the third-level algorithm share a buffer space, and the second-level algorithm and the third-level algorithm process the window data obtained from the buffer space in parallel. When the third-level algorithm processes the second window data, it does not rely on the processing result of the second-level algorithm. It only needs to merge the processing result of the second window data with the processing result of the second-level algorithm and output the merged result to the subsequent algorithm.

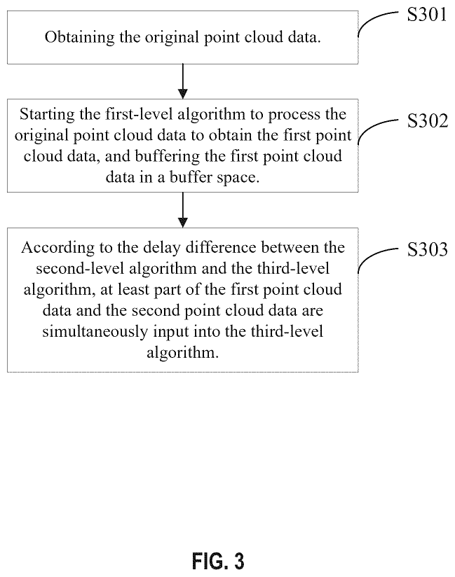

Refer to FIG. 3, which is a schematic diagram of a flow diagram of a point cloud processing method disclosed in an embodiment of the present application.

The point cloud processing method is applied to an image signal processor, which is configured on LiDAR. The image signal processor is configured to run multi-level algorithms for point cloud processing. The multi-level algorithms include the first-level algorithm, the second-level algorithm, and the third-level algorithm. The image signal processor includes a buffer space, where the first-level algorithm, the second-level algorithm, and the third-level algorithm share a buffer space.

As shown in FIG. 3, the point cloud processing method includes:

Step S301: obtaining original point cloud data.

In an embodiment, the LiDAR emits outgoing laser beams to the detection area and receives the returned echo laser beams, and obtains the original point cloud data by solving the relative relationship between the outgoing laser beams and the echo laser beams, thereby the image signal processor processes each frame of the original point cloud data. The detection area is the area where the outgoing laser beams are projected. In some embodiments of the present application, there are no restriction on the size, position, and the number of obstacles contained in the detection area.

Step S302: starting the first-level algorithm to process the original point cloud data to obtain the first point cloud data, and buffering the first point cloud data in a buffer space.

In an embodiment, the image signal processor starts the first-level algorithm to process each frame of original point cloud data, obtains several lines of the first point cloud data, and buffers the first point cloud data in a buffer space.

In an embodiment, when the first-level algorithm is a two-dimensional sorting algorithm or a coding correction algorithm, the image signal processor starts the first-level algorithm to directly obtain the original point cloud data from the storage area of the original point cloud data for processing, and buffers the obtained first point cloud data in a buffer space. There is no need to store the original point cloud data in a buffer space first and then read the original point cloud data from the buffer space. Compared with the existing solution that repeatedly transfers the original point cloud data, which is time-consuming and wastes storage area, the present application can save both the time and storage area required for transferring the original point cloud data.

Step S303: according to the delay difference between the second-level algorithm and the third-level algorithm, at least part of the first point cloud data and the second point cloud data are simultaneously input into the third-level algorithm.

The second-level algorithm is configured to process the obtained first point cloud data to obtain the second point cloud data. The third-level algorithm is configured to process the obtained first point cloud data, for example, to process part of the obtained first point cloud data to obtain the third point cloud data, and to merge the second point cloud data and the third point cloud data to output the merged result.

In an embodiment, the image signal processor controls the time for the second-level algorithm and the third-level algorithm to obtain the corresponding window data according to the delay difference between the second-level algorithm and the third-level algorithm. Accordingly, after the second-level algorithm processes and obtains the second point cloud data corresponding to a point data, the window data and the second point cloud data corresponding to the third-level algorithm are simultaneously input into the third-level algorithm. Subsequently, after the third-level algorithm processes each obtained point data to obtain the corresponding third point cloud data, it can merge the third point cloud data and the second point cloud data corresponding to the same point data and output the merged result.

The first point cloud data is a general term for point cloud data at different stages. The point cloud data is a collection of a large amount of point data, for example, the point cloud data includes 125 point data, the point data is the data of each detection point, and the window data is the part of the data obtained from the first point cloud data.

Both the second-level algorithm and the third-level algorithm read the first point cloud data in a buffer space through a sliding window to obtain the corresponding window data. The window data refers to the window data of the sliding window, which is composed of a number of point data. The window data is generally an odd number of lines, that is, in the first point cloud data, a sliding window of N*N is centered on the point to be processed, and the data in the sliding window is the window data, and N is usually a positive integer. The second-level algorithm corresponds to the first sliding window, and the third-level algorithm corresponds to the second sliding window. The window data includes the first window data or the second window data, the first sliding window corresponds to the first window data, and the second sliding window corresponds to the second window data.

Refer to FIG. 2 again, the second-level algorithm reads the first point cloud data in a buffer space through the first sliding window to obtain the first window data, and processes the first window data to obtain the second point cloud data. The third-level algorithm reads the first point cloud data in a buffer space through the second sliding window to obtain the second window data. The second window data and the second point cloud data are simultaneously input into the third-level algorithm. The third-level algorithm does not need to buffer the second window data and the second point cloud data. The third-level algorithm directly processes the second window data to obtain the third point cloud data, and merges the third point cloud data corresponding to the same point data with the second point cloud data, and outputs the merged result to the subsequent algorithm.

The second-level algorithm or the third-level algorithm processes the corresponding window data, and the obtained result is the operation result of the center point of the window data (i.e., the point data currently being operated). In some embodiments, the point data of a detection point in the original point cloud data may include information such as coordinates, distance, and reflectivity. After the second-level algorithm, the measurement results such as distance and reflectivity may be corrected, or new feature quantities may be added to the point data, such as noise markers.

On the one hand, the present application parallelizes the processing of the second-level algorithm and the third-level algorithm. Accordingly, when calculating the total delay of the multi-level algorithms, the first overall delay corresponding to the second-level algorithm can be included in the second overall delay corresponding to the third-level algorithm. Compared with the serial data stream processing structure in FIG. 1, the delay of waiting for the processing results of the second-level algorithm is saved.

On the other hand, the first-level algorithm, the second-level algorithm, and the third-level algorithm in the present application only require a total of 15 lines of a buffer space. Compared with the serial data stream processing structure in FIG. 1, which requires at least 15+2+8 lines of buffer space, the parallel data stream processing structure in the present application can reduce the required buffer space, thereby reducing the area of the radar chip and decreasing the power consumption of the radar chip.

In an embodiment of the present application, the second-level algorithm corresponds to the first overall delay, and the first overall delay includes the first window taking delay and the first processing delay. The first window taking delay includes the time for the first sliding window to obtain the first window data from a buffer space, and the first processing delay includes the time for the second-level algorithm to process the first window data to obtain the second point cloud data.

The third-level algorithm corresponds to the second overall delay, where the second overall delay includes the second window taking delay and the second processing delay, the second window taking delay includes the time for the second sliding window to obtain second window data from a buffer space, and the second processing delay includes the time for the third-level algorithm to process the second window data to obtain third point cloud data.

In an embodiment of the present application, the second-level algorithm and the third-level algorithm correspond to an overall delay respectively, and each overall delay includes the time for the sliding window to obtain the window data from a buffer space and the time for the algorithm to process the window data. The present application can facilitate the subsequent calculation of the delay difference between the second-level algorithm and the third-level algorithm according to the first overall delay and the second overall delay, so as to achieve the second point cloud data processed by the second-level algorithm and the first point cloud data read from a buffer space are simultaneously input into the third-level algorithm. In the above process, the third-level algorithm does not rely on the processing results of the second-level algorithm when processing the first point cloud data. Therefore, the second-level algorithm and the third-level algorithm can be processed in parallel. Furthermore, since the processing results of the second-level algorithm and the third-level algorithm need to be transmitted to the subsequent algorithm, the second point cloud data and the third point cloud data need to be aligned and merged, and the merged result is output to the subsequent algorithm.

In some embodiments of the present application, the multi-level algorithms further include a fourth-level algorithm, and the image signal processor outputs the merged result calculated by the third-level algorithm to the fourth-level algorithm, so that the fourth-level algorithm processes the merged result.

In an embodiment, the second-level algorithm is a noise detection algorithm, which is configured to detect and mark noise points. The marked noise points need to be transmitted to the next level algorithm. The third-level algorithm does not need to employ these noise points in the process of processing the first point cloud data. The subsequent algorithms, such as the fourth-level algorithm, may employ these noise points. Therefore, the processing results of the second-level algorithm need to be retained, and the third-level algorithm merges the second point cloud data and the third point cloud data, and outputs the merged result to the fourth-level algorithm.

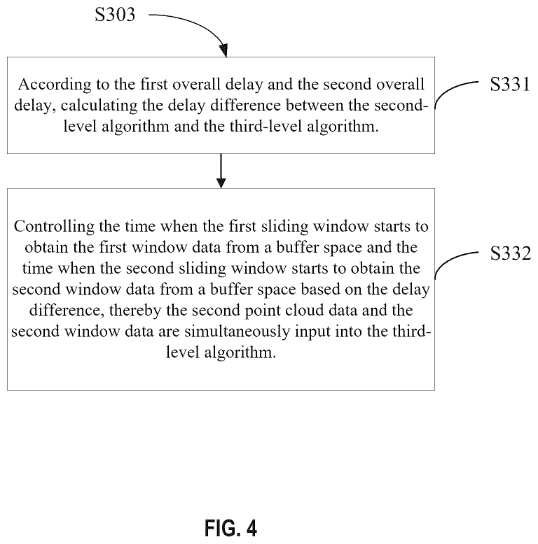

Refer to FIG. 4, which is schematic diagram of a detailed flow diagram of step S303 in FIG. 3.

As shown in FIG. 4, the step S303 includes:

Step S331: according to the first overall delay and the second overall delay, calculating the delay difference between the second-level algorithm and the third-level algorithm

The delay difference between the second-level algorithm and the third-level algorithm is the absolute value of the difference between the first overall delay and the second overall delay, where the first overall delay, the second overall delay, and the delay difference can be characterized by the amount of time or by the number of lines of point cloud data.

In some embodiments, since the ISP is a digital circuit, the digital circuit works according to a fixed clock beat, and each clock beat can read a line of point cloud data. Therefore, the number of clock beats for reading multiple lines of point cloud data can be configured to characterize the amount of time. The present application adopts the number of lines of the transmitted point cloud data to characterize the number of clock beats for transmitting the corresponding number of lines of the point cloud data. That is, the number of lines of point cloud data is configured to characterize the amount of time.

Step S332: controlling the time when the first sliding window starts to obtain the first window data from a buffer space and the time when the second sliding window starts to obtain the second window data from a buffer space based on the delay difference, thereby the second point cloud data and the second window data are simultaneously input into the third-level algorithm.

When the first overall delay is less than the second overall delay, the image signal processor first controls the second sliding window to start obtaining the second window data from a buffer space, and when the number of lines of the first point cloud data read by the second sliding window corresponds to the delay difference between the second-level algorithm and the third-level algorithm, controls the first sliding window to start obtaining the first window data from a buffer space, thereby the second window data and the second point cloud data are aligned and can be simultaneously input into the third-level algorithm.

When the first overall delay is equal to the second overall delay, the image signal processor controls the first sliding window and the second sliding window to simultaneously obtain the first window data and the second window data from a buffer space respectively, thereby the second window data and the second point cloud data are simultaneously input into the third-level algorithm

When the first overall delay is greater than the second overall delay, the image signal processor first controls the first sliding window to start obtaining the first window data from a buffer space. When the number of lines of the first point cloud data read by the first sliding window corresponds to the delay difference between the second-level algorithm and the third-level algorithm, the image signal processor controls the second sliding window to start obtaining the second window data from a buffer space. In this way, the second window data and the second point cloud data are aligned and can be simultaneously input into the third-level algorithm. The following provides, as an example, the condition where the first overall delay is less than the second overall delay as an example to illustrate the specific implementation method of step S332. The condition where the first overall delay is equal to or greater than the second overall delay is similar and will not be repeated here.

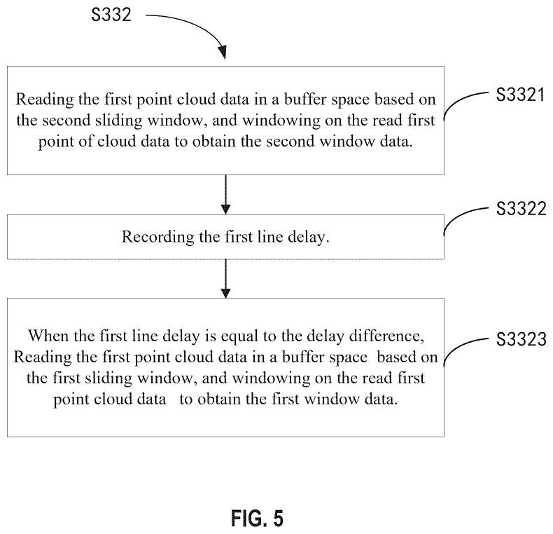

Refer to FIG. 5, which is a schematic diagram of a detailed flow diagram of step S332 in FIG. 4.

As shown in FIG. 5, the step S332 includes:

Step S3321: reading the first point cloud data in a buffer space based on the second sliding window, and windowing on the read first point of cloud data to obtain the second window data.

In an embodiment, when the first overall delay is less than the second overall delay, after the image signal processor recognizes the frame start indication signal of the first point cloud data of a frame, the image signal processor controls the second sliding window to read the first point cloud data in a buffer space, and the read first point of cloud data is windowed to obtain the second window data. The frame start indication signal is configured to instruct the sliding window to start reading the first point cloud data from the buffer space. Furthermore, each time second window data is obtained, the image signal processor processes the second window data based on the third-level algorithm to obtain the corresponding third point cloud data.

Step S3322: recording the first line delay.

The first line delay is configured to characterize the number of lines of the first point cloud data read by the second sliding window.

Step S3323: when the first line delay is equal to the delay difference, reading the first point cloud data in a buffer space based on the first sliding window, and windowing on the read first point cloud data is windowed to obtain the first window data.

In an embodiment, when the first line delay is equal to the delay difference between the second-level algorithm and the third-level algorithm, the image signal processor controls the first sliding window to start reading the first point cloud data in a buffer space, and the read first point cloud data is windowed to obtain the first window data.

The step of controlling the sliding window to read the first point cloud data in a buffer space and windowing the read first point cloud data includes: sliding the window from left to right for each point data contained in a line of the first point cloud data in turn, thereby windowing with each point data as the center to obtain corresponding window data. After completing the sliding window for a line of the first point cloud data, the image signal processor controls the sliding window to perform window sliding for the next line of the first point cloud data, until the second-level algorithm or the third-level algorithm corresponding to the sliding window completes processing of all the first point cloud data of the current frame.

In an embodiment, a line of the first point cloud data in a buffer space includes 125 point data, and the size of the sliding window is 3×3. When the sliding window slides the first line of the first point cloud data from left to right, each point data is taken as the center of the sliding window in turn, the data in the sliding window is read, and the corresponding window data is obtained by windowing. After the sliding window completes processing of the first line of the first point cloud data, the sliding window slides the next line of the first point cloud data; and so on, until the second-level algorithm or the third-level algorithm corresponding to the sliding window completes processing of all the first point cloud data of the current frame.

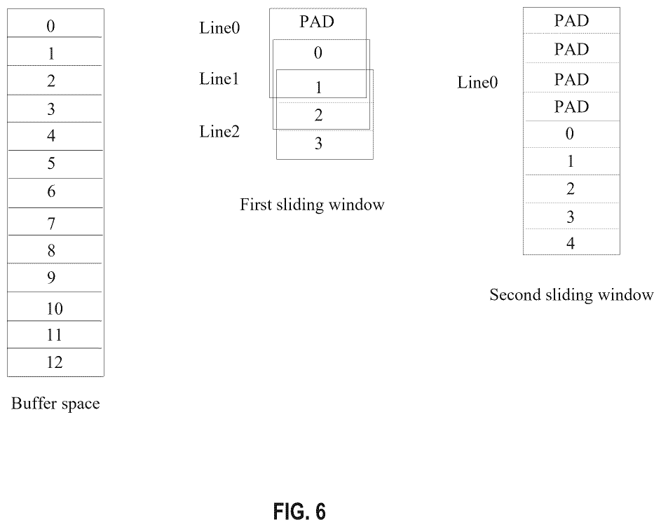

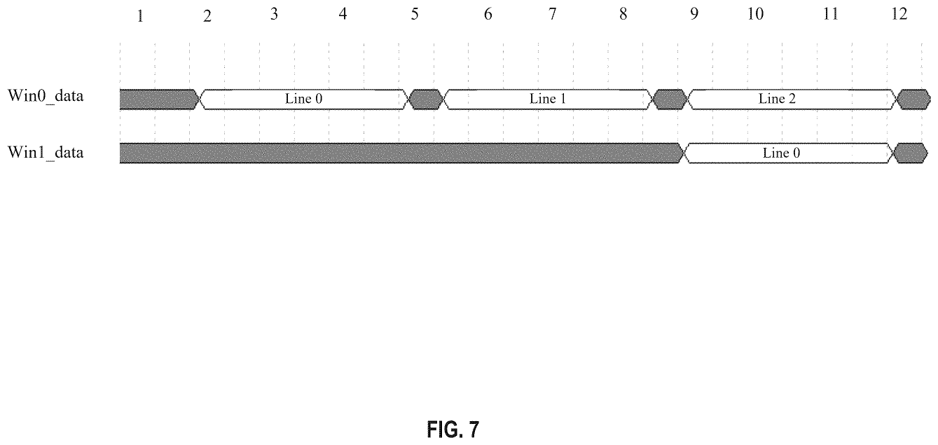

Refer to FIG. 6 and FIG. 7. FIG. 6 is a schematic diagram of the first sliding window and the second sliding window obtaining corresponding window data from a buffer space disclosed in an embodiment of the present application. FIG. 7 is a schematic diagram of an output timing of the first window data and the second window data disclosed in an embodiment of the present application.

As shown in FIG. 6, the depth of a buffer space is 15 lines, the number of lines of the first sliding window is 3 lines, and the number of lines of the second sliding window is 9 lines. 0, 1, 2, . . . , 14 represent the line numbers of the first point cloud data stored in the buffer space. Line0 is the first window data obtained by the sliding window performing windowing, line1 is the second window data obtained by the sliding window performing windowing, and line2 is the third window data obtained by the sliding window performing windowing. PAD represents that the window data is filled with invalid data in the area outside the first point cloud data of a frame, for example, it is filled with 0.

The sliding window starts sliding with the 0th line in a buffer space (the boundary of the first point cloud data of a frame) as the center line. For the first sliding window, when it takes the 0th line in the buffer space as the center line, the first sliding window has 1 line outside the first point cloud data of the frame, so the first line of the first sliding window needs to be filled with 0. For the second sliding window, when it takes the 0th line in a buffer space as the center line, the first 4 lines of the second sliding window are outside the first point cloud data of the frame and need to be filled with 0.

The window data obtained by windowing the first sliding window with the point data on line 0 as the center corresponds to the first point cloud data in the 0th and 1st lines of a buffer space. The window data obtained by windowing the first sliding window with the point data on line1 as the center corresponds to the first point cloud data in the 0th, 1st and 2nd lines of the buffer space. The window data obtained by windowing the first sliding window with the point data on line2 as the center corresponds to the first point cloud data in the 1st, 2nd and 3rd lines of the buffer space, and so on. Similarly, the window data obtained by windowing the second sliding window with the point data on line0 as the center corresponds to the first point cloud data in the 0th, 1st, 2nd, 3rd, and 4th lines of the buffer space.

As shown in FIG. 7, win0_data is the first window data, win1_data is the second window data, the horizontal axis represents the time sequence of the sliding window output window data (in lines to characterize the delay time), and the gray part is invalid data (line gap). When the first sliding window outputs line 2, the second sliding window outputs line 0.

In an embodiment of the present application, the method includes controlling the time for the first sliding window to obtain the first window data from a buffer space based on the delay difference between the second-level algorithm and the third-level algorithm, and controlling the time for the second sliding window to obtain the second window data from the buffer space. The present application can enable the first-level algorithm, the second-level algorithm, and the third-level algorithm to share a buffer space and eliminates the need for a one-to-one buffer space for the second-level algorithm and the third-level algorithm to buffer the first window data and the second window data, which can reduce the area of the chip, reduce the delay of waiting for the processing results of the second-level algorithm, and reduce the power consumption of the chip.

Furthermore, each time a window is formed to obtain window data, the image signal processor processes the window data based on the corresponding algorithm, that is, operates the point data M located at the center of the window data, and assigns the obtained result to the point data M. Since the sizes of the sliding windows corresponding to the second-level algorithm and the third-level algorithm are different, the second-level algorithm operates the point data M to obtain the corresponding second point cloud data, and the second window data obtained by the third-level algorithm is also centered on the point data M. The third point cloud data obtained by the operation on the second window data and the second point cloud data output by the second-level algorithm correspond to the same point data M, so the two can be merged, where the point data M is any point data in the first point cloud data.

In an embodiment, each time a window is formed to obtain a first window data, the image signal processor processes the first window data based on the second-level algorithm to obtain corresponding second point cloud data and input the second point cloud data into the third-level algorithm. At the same time, the second window data obtained by windowing in step S2321 is also synchronously input into the third-level algorithm, thereby the third-level algorithm processes the second window data to obtain third point cloud data. At the moment, the third point cloud data and the second point cloud data are the results of different operations on the same point data. The third point cloud data is merged with the second point cloud data, and the merged result is output.

Each time a window is formed to obtain window data, there is no need to buffer the window data in a buffer space, and the window data is directly transmitted to the corresponding second-level algorithm or third-level algorithm for processing. The second window data and the second point cloud data are aligned with the delay difference, that is, the time difference between the two sliding windows to obtain the corresponding window data is the delay difference between the second-level algorithm and the third-level algorithm, and the second window data input to the third-level algorithm is centered on the point data M. At the same time, the second point cloud data input to the third-level algorithm is obtained by windowing the point data M and then calculating it with the second-level algorithm. In the present application, the third point cloud data and the second point cloud data are the results of different calculations on the same point data, and the two can be directly merged without buffering the second point cloud data.

In an embodiment, the first overall delay is 2 lines. That is, the sum of the time it takes for the first sliding window to obtain the first window data from a buffer space and the time it takes for the second-level algorithm to process the first window data to obtain the second point cloud data is 2 lines of delay. The second overall delay is 8 lines. That is, the sum of the time it takes for the second sliding window to obtain the second window data from a buffer space and the time it takes for the third-level algorithm to process the second window data to obtain the third point cloud data is 8 lines of delay. The delay difference between the second-level algorithm and the third-level algorithm is 8−2=6 lines.

The image signal processor first controls the second sliding window to start reading the first point cloud data from a buffer space and to perform windowing with a point data M as the center to obtain the second window data. When the number of lines of the first point cloud data read by the second sliding window is 6 lines, the first sliding window is controlled to start reading the first point cloud data from a buffer space and to perform windowing with the same point data M as the center to obtain the first window data, thereby the second point cloud data obtained by the second-level algorithm through processing the first window data is synchronously input into the third-level algorithm with the second window data, that is, the second point cloud data and the second window data are aligned with the time delay difference. After the third-level algorithm processes the second window data to obtain the third point cloud data, the third point cloud data corresponding to the same point data M is merged with the second point cloud data, and the merged result is output.

In an embodiment of the present application, when the first overall delay is less than the second overall delay, the image signal processor reads the first point cloud data in a buffer space based on the second sliding window and recording the number of lines of the first point cloud data read by the second sliding window. When the number of lines satisfies the processing delay of the second-level algorithm and the third-level algorithm, the first point cloud data in a buffer space is read based on the first sliding window. In the present application, the second point cloud data and the first point cloud data are to be simultaneously input into the third-level algorithm.

In an embodiment of the present application, the method also includes: determining a maximum line value based on the number of lines in the first sliding window, the number of lines in the second sliding window, the first processing delay, and the second processing delay; and determining the depth of the buffer space based on the maximum line value.

The maximum line value is the maximum value of the number of lines in the first sliding window, the number of lines in the second sliding window, the first processing delay, and the second processing delay. The depth of a buffer space is greater than or equal to the maximum line value. The depth of the buffer space can be set by technicians in this field according to actual conditions and is not limited here.

In the process of reading the first point cloud data in a buffer space through a sliding window and windowing the read first point cloud data to obtain window data, the depth of the buffer space needs to satisfy the requirement that both the first sliding window and the second sliding window can obtain the corresponding number of lines of window data from the buffer space, as well as the delay requirement for the first sliding window and the second sliding window to read the first point cloud data in the buffer space, and satisfy the requirement that the first sliding window and the second sliding window can simultaneously read the first point cloud data of the corresponding lines.

In an embodiment of the present application, the image signal processor further includes a window taking module, which is configured to control the corresponding sliding window to obtain the corresponding window data from a buffer space, and each window taking module corresponds to a sliding window. The embodiment of the present application adopts a universal window taking module to simplify the design of the chip and also facilitate the functional expansion of the chip.

The hardware structure and working logic of each sliding window are the same, so the working method and process of the first sliding window and the second sliding window are the same. The following description is provided by taking a general sliding window as an example.

In an embodiment of the present application, according to the number of lines of the sliding window, the step of reading the first point cloud data in a buffer space through the sliding window can be divided into the following two conditions.

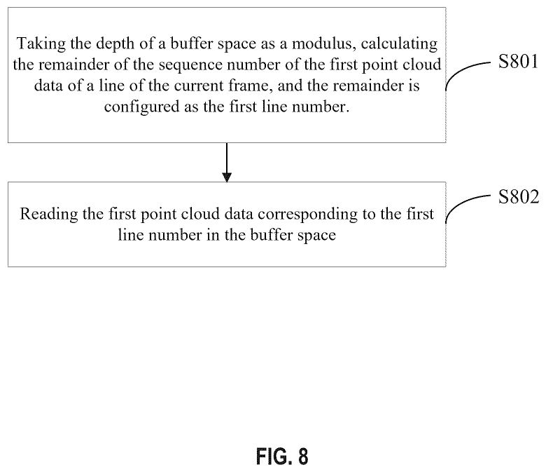

Refer to FIG. 8, which is a schematic diagram of a flow diagram of reading the first point cloud data in a buffer space through a sliding window when the number of lines of the sliding window is one line, disclosed in an embodiment of the present application.

As shown in FIG. 8, when the number of lines of the sliding window is one line, the process of reading the first point cloud data in a buffer space through the sliding window includes:

Step S801: taking the depth of a buffer space as a modulus, calculating the remainder of the sequence number of the first point cloud data of a line of the current frame, and the remainder is configured as the first line number.

In an embodiment, the image signal processor divides the sequence number of each line of the first point cloud data in the first point cloud data of the current frame by the depth of the buffer space to obtain a number of division results, and takes the remainder of each division result, where the remainder is used as the corresponding first line number. The first line number is configured to represent the storage position of a line of the first point cloud data in a frame of the first point cloud data in the buffer space. That is, the line number corresponding to a line of the first point cloud data in a frame of the first point cloud data in the buffer space.

In an embodiment of the present application, when the number of lines of the first point cloud data of a frame is greater than the depth of the buffer space, the first point cloud data is sequentially stored in the buffer space, and after the buffer space is fully occupied, the newly received line of the first point cloud data is stored in the 0th line of the buffer space to refresh the first point cloud data at the original position. For example, the number of lines of the first point cloud data of a frame is 126 lines, and the depth of the buffer space is 15 lines. After the first 15 lines of the first point cloud data of the frame are stored in the buffer space, the 16th line of the first point cloud data is stored in the 0th line of the buffer space.

Therefore, assuming that the depth of a buffer space is A, the first line number is counted cumulatively from 0 to A−1. Considering the back-to-back transmission between frames, when crossing frames, the first line number of the first point cloud data of the next frame in the buffer space is still accumulated on the basis of the previous frame.

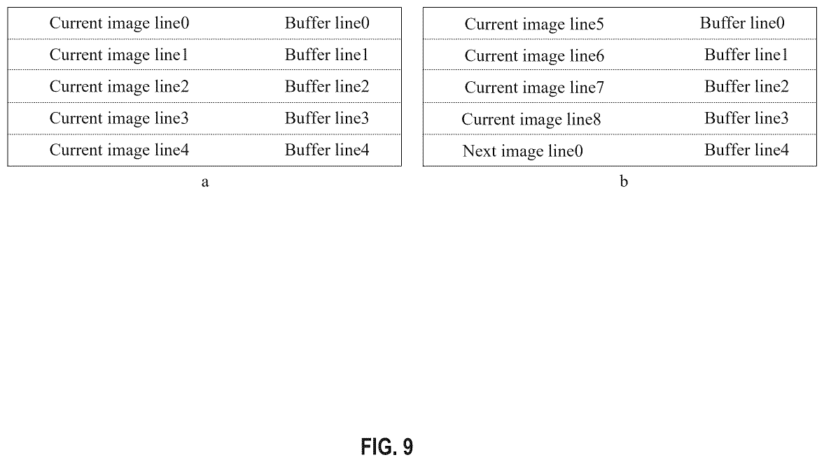

Refer to FIG. 9, which is a schematic diagram of a buffer space storing first point cloud data disclosed in an embodiment of the present application.

The part a and part b in FIG. 9 are schematic diagrams of the storage conditions when the same buffer space receives a frame of first point cloud data at different times. The depth of the buffer space is 5 lines, and the line numbers of each line are 0, 1, 2, 3, and 4, respectively. Buffer line0 represents the 0th line of the buffer space, buffer line1 represents the 1st line of the buffer space, buffer line2 represents the 2nd line of the buffer space, buffer line3 represents the 3rd line of the buffer space, and buffer line4 represents the 4th line of the buffer space.

The first point cloud data of a frame is 9 lines. The current image is the first point cloud data of a frame currently received in the buffer space. The next image is the first point cloud data of the next frame. The current image line0 represents the first point cloud data of the 0th line in the current image. The current image line1 represents the first point cloud data of the 1st line in the current image, and so on. The next image line0 represents the first point cloud data of the 0th line in the next image.

As shown in part a of FIG. 9, the first point cloud data of lines 0, 1, 2, 3, and 4 in the current image are sequentially stored in lines 0, 1, 2, 3, and 4 of the buffer space. At the moment, there is no free space in the buffer space, and the buffer space stores the first point cloud data received subsequently in line 0, 1, 2, 3, and 4 in sequence to cover the first point cloud data originally stored. As shown in part b of FIG. 9, the first point cloud data of lines 5, 6, 7, and 8 in the current image are stored in line 0, 1, 2, and 3 of the buffer space in sequence, and the current image is stored. The buffer space receives the first point cloud data of the next frame, and stores line 0 in the next image in line 4 of the buffer space.

In an embodiment, when the current image line7 of part b in FIG. 9 stored in buffer line 2, the sequence number of a line of first point cloud data in the first point cloud data of the current frame is 7, and the corresponding first line number is 2.

Comparing part a and part b in FIG. 9, it can be seen that as the number of frames of the first point cloud data increases, the storage position of the same line of first point cloud data in different frames in the buffer space will change. For example, the current image line0 and the next image line0 are stored in different lines of the buffer space, so the first line number needs to be calculated and updated in real time.

Step S802: reading the first point cloud data corresponding to the first line number in the buffer space.

In an embodiment, each time a first line number is calculated, the sliding window reads the first point cloud data stored at the location of the first line number in a buffer space to perform windowing on the line of first point cloud data to obtain corresponding window data.

When the number of lines of the sliding window is one line, the line number corresponding to the center line of the sliding window in the buffer space is the first line number, and the first point cloud data can be read based on the first line number.

In an embodiment of the present application, reading the corresponding first point cloud data according to the first line number when the number of lines in the sliding window is one line. The present application can read the first point cloud data in the buffer space according to the mapping relationship between the center line of the sliding window and the line in the buffer space.

In an embodiment of the present application, when the number of lines of the sliding window is multiple lines, the process of the sliding window reading the first point cloud data includes the first sliding window stage, the second sliding window stage, and the third sliding window stage.

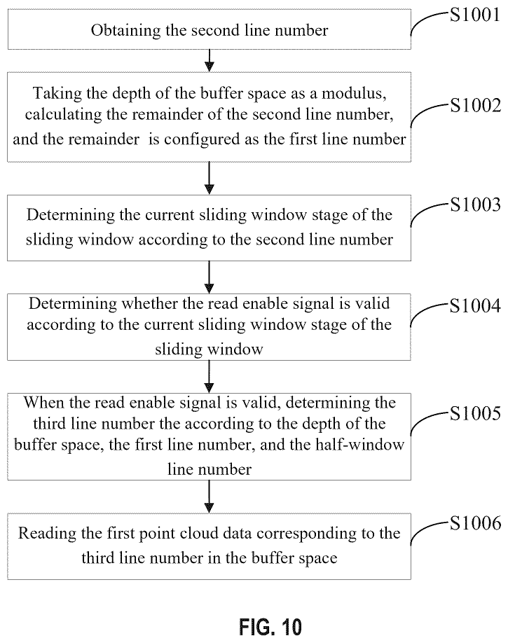

Refer to FIG. 10, which is a schematic diagram of a flow diagram of reading first point cloud data in a buffer space through a sliding window when the number of lines in the sliding window is multiple lines, disclosed in an embodiment of the present application.

As shown in FIG. 10, when the number of lines of the sliding window is multiple lines, the process of reading the first point cloud data in the buffer space through the sliding window includes:

Step S1001: obtaining the second line number.

The second line number is the line number of a line of the first point cloud data of the current frame corresponding to the center line of the sliding window, that is, the line number of a line of the first point cloud data corresponding to the center line of the sliding window in the first point cloud data of the current frame. As shown in FIG. 9, when the center line of the sliding window corresponds to current image line7, the second line number is 7. Each sliding window corresponds to a second line number, and the absolute value of the difference between the second line number corresponding to the first sliding window and the second line number corresponding to the second sliding window is equal to the delay difference between the second-level algorithm and the third-level algorithm. When the first overall delay is less than the second overall delay, the difference between the second line number corresponding to the second sliding window and the second line number corresponding to the first sliding window is equal to the difference between the second overall delay and the first overall delay (i.e., the delay difference). When the first overall delay is equal to the second overall delay, the second line numbers corresponding to the two sliding windows are the same; when the first overall delay is greater than the second overall delay, the difference between the second line number corresponding to the first sliding window and the second line number corresponding to the second sliding window is equal to the difference between the first overall delay and the second overall delay (i.e., the delay difference).

Step S1002: taking the depth of the buffer space as a modulus, calculating the remainder of the second line number, and the remainder is configured as the first line number.

In an embodiment, the image signal processor divides the second line number by the depth of the buffer space to obtain a division result, and takes the remainder of the division result as the first line number. At the moment, the first line number represents the line number corresponding to the center line of the sliding window in the buffer space.

As shown in FIG. 9, when the center line of the sliding window corresponds to current image line 7, that is, the center line of the sliding window corresponds to the first point cloud data of the 7th line in the current image, at the moment, the second line number is 7, and the corresponding first line number is 2, that is, the center line of the sliding window corresponds to the 2nd line in the buffer space, that is, the 7th line in the current image is stored in the 2nd line in the buffer space.

In an embodiment of the present application, the buffer space supports writing the first point cloud data while the first point cloud data is read by the sliding window. There is a delay of half a window line in writing and reading the first point cloud data. After the buffer space receives a frame of first point cloud data, the sliding window is controlled to continue sliding down by half-window line until the second-level algorithm or the third-level algorithm corresponding to the sliding window completes processing of all the first point cloud data of the current frame.

In an embodiment of the present application, the point cloud processing method also includes: in the process of sliding the sliding window downward, when the buffer space receives the first point cloud data of the next frame, the first point cloud data of the next frame is stored in the next line of the first point cloud data of the last line of the current frame in the buffer space.

In an embodiment, after the end of the frame of the first point cloud data of the previous frame is written into the buffer space, while the sliding window continues to slide down half-window line, when the buffer space receives the first point cloud data of the next frame, the buffer space stores the first point cloud data of the next frame in the next line following the last line of the first point cloud data of the current frame in the buffer space. That is, the first point cloud data of the next frame is stored in the next line of the frame end pointer of the first point cloud data of the previous frame.

In an embodiment, when the frame end pointer of the first point cloud data of the previous frame is H−1, the frame head pointer of the first point cloud data of the next frame is H. That is, the last line of the first point cloud data of the previous frame is stored in the (H−1)th line of the buffer space, and the first line of the first point cloud data of the next frame is stored in the Hth line of the buffer space, where H is the line number of any line in the buffer space.

In an embodiment of the present application, storing the first point cloud data of the next frame in the next line of the first point cloud data of the last line of the current frame in the buffer space during the process of the sliding window sliding downward. In the present application, the two consecutive frames of first point cloud data seamlessly cross frames (the frame gap is approximately 0), thereby saving buffer space. However, the method will affect the situation where the sliding window obtains window data beyond the upper boundary or lower boundary of a frame of first point cloud data, that is, it affects the sliding window in obtaining window data in the first sliding window stage or the third sliding window stage. Therefore, it is necessary to determine the current sliding window stage of the sliding window according to the second line number, and thereby determine whether the read enable signal is valid according to the current sliding window stage of the sliding window.

Step S1003: determining the current sliding window stage of the sliding window according to the second line number.

In an embodiment, according to the time sequence of windowing, the process of the sliding window reading point cloud data from the first point cloud data of a frame is divided into three sliding window stages: in the first sliding window stage, the part of the upper area of the sliding window exceeds the upper boundary of the first point cloud data of a frame; in the second sliding window stage, the entire sliding window is located between the upper boundary and the lower boundary of the first point cloud data of a frame; and in the third sliding window stage, the part of the lower area of the sliding window exceeds the lower boundary of the first point cloud data of a frame.

The image signal processor determines the current sliding window stage of the sliding window according to the size relationship between the second line number B, the half-window line number C, and the preset line number (D−1). The half-window line number C is obtained by rounding down half of the number of lines of the sliding window, the preset line number (D−1) is the total number of lines of the first point cloud data of a frame minus one, and D represents the total number of lines of the first point cloud data of a frame.

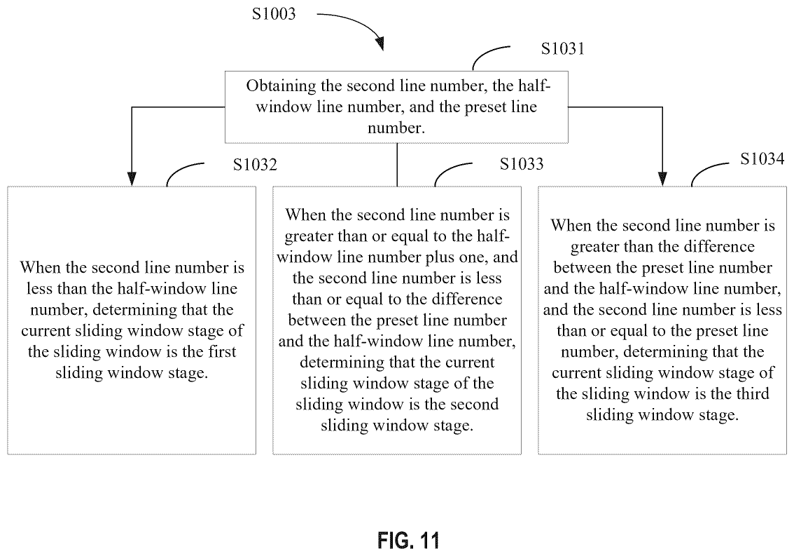

Refer to FIG. 11, which is a schematic diagram of a detailed flow diagram of step S1003 in FIG. 10.

As shown in FIG. 11, the step S1003 includes:

Step S1031: obtaining the second line number, the half-window line number, and the preset line number.

Step S1032: when the second line number is less than the half-window line number, determining that the current sliding window stage of the sliding window is the first sliding window stage.

In an embodiment, when the second line number B is less than the half-window line number C, the central line of the sliding window is in the process of sliding from the 0th line to Cth line, and the image signal processor determines that the current sliding window stage of the sliding window is the first sliding window stage.

When the sliding window is windowing in the stage, the window data of the area above the first point cloud data of the 0th line obtained by the sliding window will be filled with zero. During the sliding window process, the area outside the upper boundary of the first point cloud data of a frame will gradually slide out of the window range. At least one line of the upper half of the sliding window in the stage needs to be filled with zero when the window is windowing. For example, when the sliding window is a 3×3 window, when the sliding window takes the first line of data of the first point cloud data of a frame, it is in the first sliding window stage, the second line of the sliding window (i.e., the center line) takes the first line of data of the first point cloud data, and the third line of the sliding window takes the second line of data of the first point cloud data. At the moment, the first line of the sliding window slides out of the upper boundary of the first point cloud data, so the first line of data of the sliding window is set to zero.

Step S1033: when the second line number is greater than or equal to the half-window line number plus one, and the second line number is less than or equal to the difference between the preset line number and the half-window line number, determining that the current sliding window stage of the sliding window is the second sliding window stage.

In an embodiment, when the second line number B is greater than or equal to the half-window line number C plus one, and the second line number B is less than or equal to the difference between the preset line number (D−1) and the half-window line number C, the center line of the sliding window is in the process of sliding the window from the (C+1)th line to the (D−1−C)th line, and the image signal processor determines that the sliding window is currently in the second sliding window stage. In this stage, the data read by the sliding window are all between the upper and lower boundaries of the first point cloud data of a frame.

Step S1034: when the second line number is greater than the difference between the preset line number and the half-window line number, and the second line number is less than or equal to the preset line number, determining that the current sliding window stage of the sliding window is the third sliding window stage.

In an embodiment, when the second line number B is greater than the difference between the preset line number (D−1) and the half-window line number C, and the second line number B is less than or equal to the preset line number (D−1), the center line of the sliding window is in the sliding window process from the (D−C)th line to the (D−1)th line, and the image signal processor determines that the current sliding window stage of the sliding window is the third sliding window stage.

When the sliding window is windowing in the stage, the window data of the area below the last line of the first point cloud data obtained by the sliding window will be filled with zero. During the sliding window process, the area outside the lower boundary of the first point cloud data of a frame will gradually slide into the window range. At least one line of the lower half of the sliding window in the stage needs to be filled with zero when the window is windowing. For example, when the sliding window is a 3×3 window, when the sliding window takes the last line of data of the first point cloud data of a frame, it is in the third sliding window stage. The second line (i.e., the center line) of the sliding window takes the last line of the first point cloud data, and the first line of the sliding window takes the second to last line of the first point cloud data. At the moment, the third line of the sliding window slides out of the lower boundary of the first point cloud data, so the third line of the sliding window is set to zero.

In an embodiment of the present application, determining the current sliding window stage of the sliding window according to the second line number, the half-window number line, and the preset line number, it is possible to subsequently determine whether to read the first point cloud data corresponding to the third line number according to the sliding window stage, thereby avoiding reading the data of the previous frame or the next frame that is continuously stored, causing windowing error.

Step S1004: determining whether the read enable signal is valid according to the current sliding window stage of the sliding window.

In an embodiment, the image signal processor determines whether the read enable signal corresponding to the third line number in the current sliding window stage of the sliding window is valid, and the read enable signal is configured to determine whether to read the first point cloud data corresponding to the third line number in the buffer space. When the read enable signal is valid, the first point cloud data corresponding to the third line number is read in the buffer space; when the read enable signal is invalid, the first point cloud data corresponding to the third line number is not read. The third line number E[i] is the line number corresponding to the ith line in the sliding window in the buffer space.

In an embodiment of the present application, step S1004 includes: in the first sliding window stage, when the first line number is greater than or equal to zero, determining that the read enable signal is valid, when the first line number is less than zero, determining that the read enable signal is invalid; in the second sliding window stage, determining that the read enable signal is valid; and in the third sliding window stage, when the first line number is less than or equal to the preset line number, determining that the read enable signal is valid, when the first line number is greater than the preset line number, determining that the read enable signal is invalid.

The first line number is the difference between the second line number and the half-window line number plus i, where i is the line number of any line in the sliding window in the sliding window, and the preset line number is the total number of lines of the first point cloud data of a frame minus one.

In an embodiment, each line in the sliding window corresponds to a first line number and a third line number. In different sliding window stages, the first line number is determined by a general formula win_line(i). The calculation formula of win_line(i) is as follows:

$$win\_line ( i ) = B - C + i$$

The win_line(i) represents the quantity related to the line number of the ith line in the sliding window, B represents the second line number, C represents the half-window line number, i is the line number of any line in the sliding window, i∈[0,F−1], and F represents the number of lines in the sliding window.

In each sliding window stage, the calculation result of the corresponding win_line(i) is the first line number corresponding to the ith line in the sliding window. In different sliding window stages, whether the read enable signal is valid is determined according to the comparison result of win_line(i). In the first sliding window stage, when the first line number win_line(i) corresponding to the ith line in the sliding window is greater than or equal to zero, it is that the ith line in the sliding window slides between the upper and lower boundaries of the first point cloud data of a frame. Therefore, it is determined that the read enable signal corresponding to the third line number E[i] is valid, and the first point cloud data corresponding to the third line number is read from the buffer space.

In the first sliding window stage, when the first line number win_line(i) corresponding to the ith line in the sliding window is less than zero, it is that the ith line in the sliding window slides out of the upper boundary of the first point cloud data of the current frame. Therefore, it is determined that the read enable signal corresponding to the third line number E[i] is invalid, and the point data is not read from the buffer space. Instead, the ith line data in the sliding window is set to zero.

In the second sliding window stage, each line in the sliding window slides between the upper and lower boundaries of first point cloud data of a frame. Therefore, it is determined that the read enable signal corresponding to the third line number E[i] is always valid. That is, in the second sliding window stage, each first point cloud data corresponding to the third line number can be read.

In the third sliding window stage, when the first line number win_line(i) corresponding to the ith line in the sliding window is less than or equal to the preset line number, it is that the ith line in the sliding window slides between the upper and lower boundaries of first point cloud data of a frame. Therefore, it is determined that the read enable signal corresponding to the third line number E[i] is valid, and the first point cloud data corresponding to the third line number is read from the buffer space.

When the first line number win_line(i) corresponding to the ith line in the sliding window is greater than the preset line number, it is that the ith line in the sliding window slides out of the lower boundary of the first point cloud data of the current frame. Therefore, it is determined that the read enable signal corresponding to the third line number E[i] is invalid, and the point data is not read from the buffer space. Instead, the ith line data in the sliding window is set to zero.

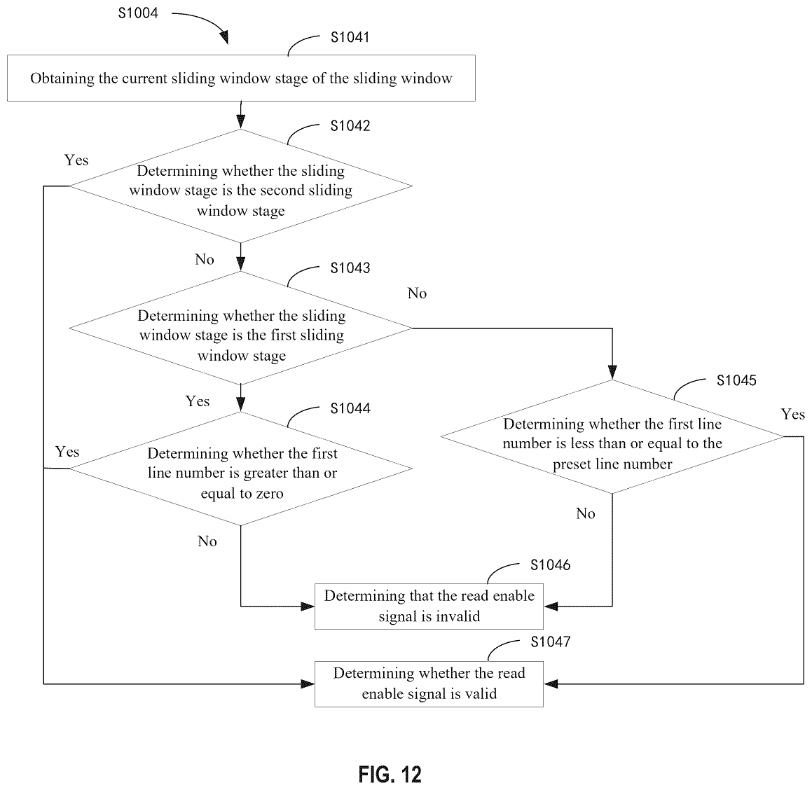

Refer to FIG. 12, which is a schematic diagram of a detailed flow diagram of step S1004 in FIG. 10.

As shown in FIG. 12, the step S1004 includes:

Step S1041: obtaining the current sliding window stage of the sliding window.

Step S1042: determining whether the sliding window stage is the second sliding window stage.

In an embodiment, when the current sliding window stage is the second sliding window stage, the process proceeds to step S1047. When the current sliding window stage is not the second sliding window stage, the process proceeds to step S1043.

Step S1043: determining whether the sliding window stage is the first sliding window stage.

In an embodiment, when the current sliding window stage is the first sliding window stage, the process proceeds to step S1044. When the current sliding window stage is not the first sliding window stage, the process proceeds to step S1045.

Step S1044: determining whether the first line number is greater than or equal to zero.

In an embodiment, when the current sliding window is the first sliding window stage, the image signal processor determines whether the first line number win_line(i) corresponding to each line in the sliding window is greater than or equal to zero.

When the first line number corresponding to the ith line in the sliding window is greater than or equal to zero, the process proceeds to step S1047. When the first line number corresponding to the ith line in the sliding window is less than zero, the process proceeds to step S1046.

Step S1045: determining whether the first line number is less than or equal to the preset line number.

In an embodiment, when the current sliding window is the third sliding window stage, the image signal processor determines whether the first line number win_line(i) corresponding to each line in the sliding window is less than or equal to the preset line number (D−1).

When the first line number corresponding to the ith line in the sliding window is less than or equal to the preset line number, the process proceeds to step S1047. When the first line number corresponding to the ith line in the sliding window is greater than the preset line number, the process proceeds to step S1046.

Step S1046: determining that the read enable signal is invalid.

In an embodiment, when the current sliding window is the first sliding window stage, the first line number win_line(i) corresponding to the ith line in the sliding window is less than zero, the image signal processor determines that the read enable signal corresponding to the third line number E[i] is invalid. Or, when the current sliding window is the third sliding window stage, the first line number win_line(i) corresponding to the ith line in the sliding window is greater than the preset line number (D−1), the image signal processor determines that the read enable signal corresponding to the third line number E[i] is invalid.

Step S1047: determining whether the read enable signal is valid.

In an embodiment, when the current sliding window is the second sliding window stage, the image signal processor determines that the read enable signal corresponding to the third line number E[i] is always valid. That is, in the second sliding window stage, each first point cloud data corresponding to the third line number can be read.

When the current sliding window is the first sliding window stage, the first line number win_line(i) corresponding to the ith line in the sliding window is greater than or equal to zero, the image signal processor determines that the read enable signal corresponding to the third line number E[i] is valid. Or, when the current sliding window is the third sliding window stage, the first line number win_line(i) corresponding to the ith line in the sliding window is less than or equal to the preset line number(D−1), the image signal processor determines that the read enable signal corresponding to the third line number E[i] is valid.

In an embodiment of the present application, determining whether the read enable signal corresponding to the third line number is valid according to the sliding window stage and the size of the first line number, the present application can determine which lines in the buffer space are the lines that the current sliding window needs to read, and does not read the lines in the non-sliding window.

Step S1005: when the read enable signal is valid, determining the third line number the according to the depth of the buffer space, the first line number, and the half-window line number.

In an embodiment, when the read enable signal corresponding to the third line number E[i] is valid, the image signal processor determines the value of the third line number E[i] according to the depth A of the buffer space, the first line number G, and the half-window line number C.

When the number of lines in the sliding window is multiple lines, the line number corresponding to the upper boundary of the sliding window in the buffer space is G-C, the line number corresponding to the lower boundary of the sliding window in the buffer space is G+C, and the line number corresponding to the ith line between the upper boundary and the lower boundary in the buffer space can be expressed as G−C+i, i∈[0, F−1]. Since all lines in the sliding window must satisfy the condition of A as the modulus, G−C+i needs to be a non-negative number. Therefore, a bias A is added on the basis of G-C+i, and the third line number E[i] is determined by judging the size relationship between A+(G−C+i) and A.

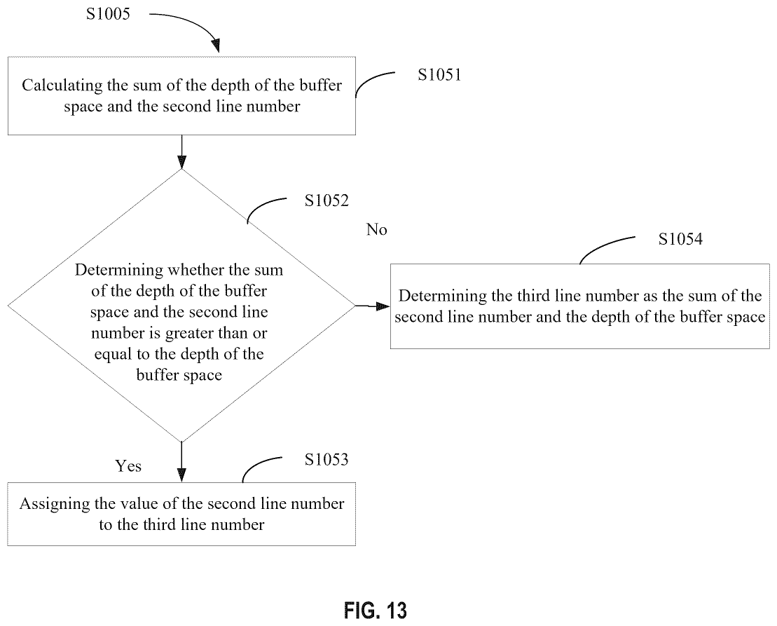

Refer to FIG. 13, which is a schematic diagram of a detailed flow diagram of step S1005 in FIG. 10.

As shown in FIG. 13, the step S1005: when the read enable signal is valid, determining the third line number according to the depth of the buffer space, the first line number, and the half-window line number, includes:

Step S1051: calculating the sum of the depth of the buffer space and the second line number.

The second line number is the difference between the first line number and the half-window line number plus i, that is, G−C+i, i is the line number of any line in the sliding window in the sliding window, and the sum of the depth of the buffer space and the second line number is A+(G−C+i).

Step S1052: determining whether the sum of the depth of the buffer space and the second line number is greater than or equal to the depth of the buffer space.

In an embodiment, the image signal processor determines whether the sum of the depth of the buffer space and the second line number is greater than or equal to the depth of the buffer space, that is, whether A+(G−C+i) is greater than or equal to A.

When the sum of the depth of the buffer space and the second line number is greater than or equal to the depth of the buffer space, the process proceeds to step S1053. When the sum of the depth of the buffer space and the second line number is less than the depth of the buffer space, the process proceeds to step S1054.

Step S1053: assigning the value of the second line number to the third line number.

In an embodiment, when the sum of the depth of the buffer space and the second line number is greater than or equal to the depth of the buffer space, the image signal processor assigns the value of the second line number to the third line number. That is, the value of the third line number E[i] is G−C+i.

Step S1054: determining the third line number as the sum of the second line number and the depth of the buffer space.

In an embodiment, when the sum of the depth of the buffer space and the second line number is less than the depth of the buffer space, then the second line number is a negative number, and its absolute value is less than or equal to the depth of the buffer space. Therefore, the image signal processor determines the third line number to be the sum of the second line number and the depth of the buffer space, that is, the value of the third line number E[i] is G−C+i+A, thereby the value of the third line number E[i] is non-negative. At this point, according to the line number index i in the sliding window, the image signal processor can calculate the line number E[i] corresponding to the ith line in the sliding window in the buffer space.

In an embodiment of the present application, by judging the size relationship between the depth of the buffer space and the sum of the second line number and the depth of the buffer space, the present application can determine whether the second line number is a positive number and when the second line number is a negative number, ensuring that the third line number does not overflow.

Step S1006: reading the first point cloud data corresponding to the third line number in the buffer space.

In an embodiment, when the read enable signal corresponding to the third line number is valid, the sliding window reads the first point cloud data corresponding to the third line number in the buffer space, and performs windowing on the first point cloud data of the current line read to obtain the corresponding window data. For example, when the third line number corresponding to the 0th line in the current sliding window is 5. That is, the 0th line in the current sliding window is mapped to the 5th line in the buffer space, and the sliding window reads the first point cloud data of the 5th line in the buffer space.

When the sliding window reads the first point cloud data stored in the buffer space, it can calculate the third line number corresponding to a line index i at each time beat according to the multiple line indexes i in the sliding window, thereby after calculating a third line number each time, a line of the first point cloud data is read in the buffer space until all lines in the sliding window obtain the corresponding point data and the window is formed.

In an embodiment of the present application, when the number of lines in the sliding window is multiple lines, whether the read enable signal corresponding to the third line number is valid is determined according to the current sliding window stage. When the read enable signal corresponding to the third line number is valid, the first point cloud data corresponding to the third line number is read in the buffer space. The present application can determine whether to read the first point cloud data corresponding to each third line number, thereby when a third line number corresponds to the upper boundary or lower boundary of first point cloud data of a frame, the corresponding first point cloud data is not read, thereby avoiding reading invalid data.

In some embodiments of the present application, the first window data output by the first sliding window and the second window data output by the second sliding window have one or more lines of overlapping first point cloud data. For example, when the first sliding window outputs line2 and the second sliding window outputs line0 in FIG. 7, line2 output by the first sliding window and line0 output by the second sliding window in FIG. 6 have three lines of overlapping first point cloud data (the 1st line, the 2nd line, and the 3rd line in the read buffer space).

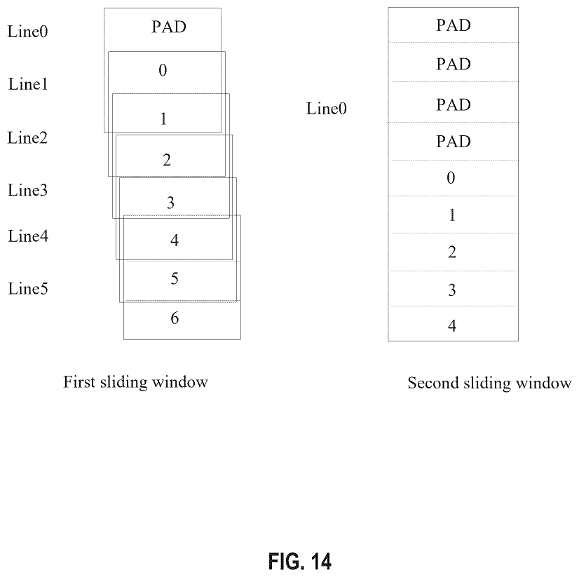

Refer to FIG. 14, which is a schematic diagram of the first sliding window and the second sliding window obtain corresponding window data from a buffer space disclosed in an embodiment of the present application.

FIG. 14 is a schematic diagram of the first sliding window continues to be windowed to obtain the first window data based on FIG. 6.

As shown in FIG. 14, line3 is the fourth first window data obtained by the first sliding window perform windowing, line4 is the fifth first window data obtained by the first sliding window perform windowing, line5 is the sixth first window data obtained by the first sliding window perform windowing, and line5 obtained by the first sliding window perform windowing corresponds to the first point cloud data in the 4th, 5th, and 6th lines of the buffer space.

When the first sliding window delays obtaining the first window data, the first sliding window outputs line5 while the second sliding window outputs line0. At the moment, line5 output by the first sliding window and line0 output by the second sliding window have one line of first point cloud data (the 4th line in the read buffer space) that overlaps.

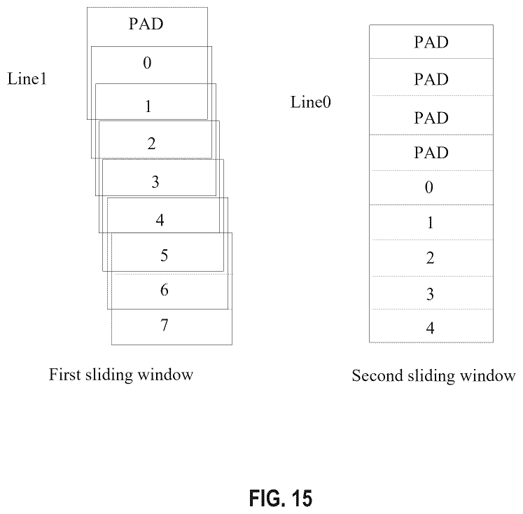

Refer to FIG. 15, which is a schematic diagram of the first sliding window and the second sliding window obtain corresponding window data from a buffer space disclosed in an embodiment of the present application.

FIG. 15 is a schematic diagram of the first sliding window continues to be windowed to obtain the first window data based on FIG. 14.

As shown in FIG. 15, line6 is the seventh first window data obtained by the first sliding window windowing, and line6 obtained by the first sliding window windowing corresponds to the first point cloud data of the 5th, 6th and 7th lines of the buffer space.

When the first sliding window delays obtaining the first window data, the first sliding window outputs line6 while the second sliding window outputs line0. At the moment, line6 output by the first sliding window and line0 output by the second sliding window have no overlapping first point cloud data.

When the first sliding window needs to read the 5th, 6th, and 7th lines in the buffer space, but the second sliding window does not need to, although the first point cloud data of the 5th, 6th, and 7th lines read in the buffer space are transmitted to the first sliding window and the second sliding window respectively according to the result of the bit or operation, the second sliding window does not receive the first point cloud data of the 5th, 6th, and 7th lines, the result of line0 output by the second sliding window is not affected, and line6 output by the first sliding window and line0 output by the second sliding window have no overlapping first point cloud data.

It can be seen from the two sliding window methods shown in FIG. 14 and FIG. 15 that different delay differences may cause some data to be accessed simultaneously. Therefore, when reading the first point cloud data in the sliding window, considering the reuse of data, the first point cloud data to be read by any sliding window is transmitted to each sliding window respectively, so that multiple sliding windows share a buffer space, which is also convenient for improving the scalability and versatility of the chip.

In an embodiment, the working logic of multiple window taking modules is the same, and multiple window taking modules transmit read requests to the buffer space according to the delay requirements, and the external buffer space only responds to the read requests, without distinguishing which window taking module the read request comes from. After multiple window taking modules receive data, each determines whether to transmit data to the corresponding algorithm module according to the read request. Each level of algorithm corresponds to an algorithm module, and the algorithm module is, for example, the second-level algorithm module or the third-level algorithm module. The second-level algorithm module is configured for performing second-level algorithm processing, and the third-level algorithm module is configured for performing third-level algorithm processing. When the chip needs to be compatible with more parallel algorithm modules, it is only necessary to leave some margins in the design and arrange several more window taking modules for easy expansion. The setting method can also be compatible with the variable delay relationship between multiple algorithm modules with strong versatility.

The window taking modules include the first window taking module and the second window taking module. The first window taking module is configured to transmit the first read request to the buffer space according to the first delay amount so that the first sliding window obtains the first window data. The second window taking module is configured to transmit the second read request to the buffer space according to the second delay amount so that the second sliding window obtains the second window data. The first delay amount represents the delay time for the first window taking module to start transmitting the first read request to the buffer space, and the second delay amount represents the delay time for the second window taking module to start transmitting the second read request to the buffer space. The first delay amount includes the first line delay parameter, and the second delay amount includes the second line delay parameter. The first line delay parameter is configured to characterize the number of delay lines for the first sliding window to read the first point cloud data, and the second line delay parameter is configured to characterize the number of delay lines for the second sliding window to read the first point cloud data. The absolute value of the difference between the first line delay parameter and the second line delay parameter is equal to the delay difference between the second-level algorithm and the third-level algorithm. The sizes of the first delay amount, the second delay amount, the first line delay parameter, and the second line delay parameter can be set by technicians in this field according to the delay difference between the second-level algorithm and the third-level algorithm, and are not limited here.

Each sliding window corresponds to a read request, the first sliding window corresponds to the first read request, the second sliding window corresponds to the second read request, the first read request and the second read request each include multiple bits, the bits correspond to the lines in the buffer space one by one, and each bit is configured to represent the value of the read enable signal of the corresponding line in the buffer space. Each third line number corresponds to a bit. For example, when the third line number is a, the read enable signal corresponding to the ath line in the buffer space is the read enable signal corresponding to the third line number.

When the value of a bit is 0, the read enable signal of the corresponding line in the buffer space is invalid. At the moment, the sliding window does not read the first point cloud data stored in the line; when the value of a bit is 1, the read enable signal of the corresponding line in the buffer space is valid. At the moment, the sliding window reads the first point cloud data stored in the line.

In some embodiments of the present application, the point cloud processing method further includes: performing an OR operation on the bits in the first read request and the second read request; when the result of the OR operation is a preset value, reading the first point cloud data stored in the corresponding line in the buffer space, and transmitting the read first point cloud data to the first sliding window and the second sliding window respectively. In an embodiment, the preset value is 1.

In an embodiment, when the image signal processor determines that the read enable signal corresponding to a third line number is invalid, the corresponding bit in the read request is marked as 0, and when the image signal processor determines that the read enable signal corresponding to a third line number is valid, the corresponding bit in the read request is marked as 1. Furthermore, the image signal processor performs an OR operation on the bits of the same line in the corresponding buffer space in the first read request and the second read request to obtain the result of the OR operation corresponding to the line, and when the result of the OR operation corresponding to any line is a preset value, for example: when the result of the OR operation is 1, the first point cloud data stored in the line of the buffer space is read, and the read first point cloud data is transmitted to the first sliding window and the second sliding window respectively. When the result of the OR operation corresponding to any line is not a preset value, for example: when the result of the OR operation is 0, the first point cloud data stored in the line of the buffer space is not read.

In an embodiment, the depth of the buffer space is 3 lines, namely line 0, line 1, and line 2 respectively. The first read request and the second read request both include 3 bits: bit 0, bit 1, and bit 2. The bit 0 corresponds to line 0 in the buffer space, bit 1 corresponds to line 1 in the buffer space, and bit 2 corresponds to line 2 in the buffer space.

The image signal processor performs an OR operation on bit 0 in the first read request and bit 0 in the second read request to obtain the result of the OR operation corresponding to line 0 in the buffer space. When the result of the OR operation is 1, the first point cloud data stored in line 0 in the buffer space is read, and the read first point cloud data is transmitted to the first sliding window and the second sliding window respectively. When the result of the OR operation is 0, the first point cloud data stored in line 0 in the buffer space is not read. The operation of the image signal processor on bit 1 or bit 2 in the first read request and the second read request is similar to the operation on bit 0, which will not be repeated here.

In an embodiment of the present application, performing an OR operation on the bits, when the result of the OR operation is a preset value, the first point cloud data stored in the corresponding line in the buffer space is read, and the read first point cloud data is transmitted to the first window and the second window respectively. When the first window and the second window read the same line of first point cloud data, the present application can transmit the line of first point cloud data to the first window and the second window respectively, thereby realizing that the first window and the second window share a buffer space.

In some embodiments of the present application, when the value of a bit in a read request (the first read request or the second read request) is 0, and the first point cloud data stored in the line in the buffer space corresponding to the bit is transmitted to the first sliding window and the second sliding window respectively, the sliding window corresponding to the read request does not perform windowing or transmit it to the corresponding algorithm module for windowing after obtaining the first point cloud data in the line.

In an embodiment, the bit 0 in the read request corresponds to 0th line in the buffer space, the value of bit 0 in the first read request is 1, the value of bit 0 in the second read request is 0, the result of the OR operation between the two is 1, and the first point cloud data of 0th line read in the buffer space is transmitted to the first sliding window and the second sliding window respectively. At the moment, the second sliding window does not receive the first point cloud data of the line.

In an embodiment of the present application, after the first point cloud data corresponding to the third line number is read from the buffer space, the sliding window is configured to window the read first point cloud data into windows. The windowing of the read first point cloud data into windows includes the following steps (1) to (3).

Step (1): when the center line of the sliding window corresponds to the 0th line in the buffer space, filling the window data corresponding to the area above the 0th line of the sliding window with zero.

Step (2): storing the first point cloud data of the current line read in sequence into the sliding window, and obtaining a window of data whenever the number of lines of the first point cloud data stored in the sliding window reaches the number of lines of the sliding window.

In an embodiment, during the process of sliding the sliding window downward, the window taking module stores the first point cloud data of the current line read in sequence into the sliding window, and obtains a window data every time when the number of lines of the first point cloud data stored in the sliding window reaches the number of lines of the sliding window.

In an embodiment, when the number of lines of the sliding window is 3, and the center line of the sliding window corresponds to the 0th line in the buffer space, the window taking module fills the window data corresponding to the area of the sliding window above the 0th line with zero, that is, fills the first line of the window data with zero, and stores the first point cloud data of the 0th line read in the buffer space into the sliding window as the second line of the window data, and the first point cloud data of the 1st line read in the buffer space as the 3rd line of the window data, thereby forming a window with three lines of window data. The first two lines of the window data need to be stored in the sliding window to wait for the formation of a complete window data. After the sliding window obtains the first point cloud data of the next line, it does not need to store the first point cloud data of the line, and directly forms a window with the first two lines of the window data to obtain a complete window data.

Step (3): after the buffer space completes storing the last line of the first point cloud data of a frame, while the sliding window is sliding downward, the window data corresponding to the area below the last line of the first point cloud data of a frame is filled with zeros until the second-level algorithm or the third-level algorithm corresponding to the sliding window completes processing of all the first point cloud data of the current frame.

In some embodiments of the present application, the image signal processor directly stores the original point cloud data in the buffer space, and the first-level algorithm is configured to process the original point cloud data in the buffer space to obtain the first point cloud data. The first-level algorithm reads the original point cloud data in the buffer space through a sliding window to obtain the corresponding window data, and then processes the window data to obtain the first point cloud data.

In an embodiment, when the first-level algorithm is configured to reverse even-numbered lines, all the obtained original point cloud data need to be buffered in the buffer space first, and then read from the buffer space based on the sliding window and process it.

In some embodiments of the present application, the number of the first-level algorithm, the second-level algorithm, and the third-level algorithms in the multi-level algorithms can be multiple. In addition, the multi-level algorithms can also include the fourth-level algorithms, the fifth-level algorithms, and other algorithms. As long as the startup calculation of the latter-level algorithm does not rely on the processing result of the previous-level algorithm, the two level algorithms can be processed in parallel and share a buffer space, thereby improving the processing efficiency of the multi-level algorithms.

In an embodiment of the present application, a point cloud processing method is provided, and the point cloud processing method is applied to an image signal processor, and the image signal processor is configured to run multi-level algorithms for point cloud processing, and the multi-level algorithms include the first-level algorithm, the second-level algorithm, and the third-level algorithm, where the first-level algorithm, the second-level algorithm, and the third-level algorithm share a buffer space. The point cloud processing method includes: obtaining the original point cloud data; starting the first-level algorithm to process the original point cloud data to obtain the first point cloud data, and buffering the first point cloud data in a buffer space; according to the delay difference between the second-level algorithm and the third-level algorithm, the first point cloud data and the second point cloud data are simultaneously input into the third-level algorithm, where the second-level algorithm is configured to process the obtained first point cloud data to obtain the second point cloud data, and the third-level algorithm is configured to process the obtained first point cloud data to obtain the third point cloud data, and merge the second point cloud data and the third point cloud data to output the merged result.

On the one hand, the first-level algorithm, the second-level algorithm, and the third-level algorithm sharing a buffer space, the present application only needs to set up one buffer space, and there is no need to set up a buffer space for each level of the algorithm, which can reduce the area of the radar chip and thus reduce the power consumption of the radar chip. On the other hand, according to the delay difference between the second-level algorithm and the third-level algorithm, the second point cloud data processed by the second-level algorithm and the first point cloud data read from a buffer space are simultaneously input into the third-level algorithm, the present application can reduce the delay of waiting for the processing result of the second-level algorithm, thereby reducing the overall delay of the image signal processor.

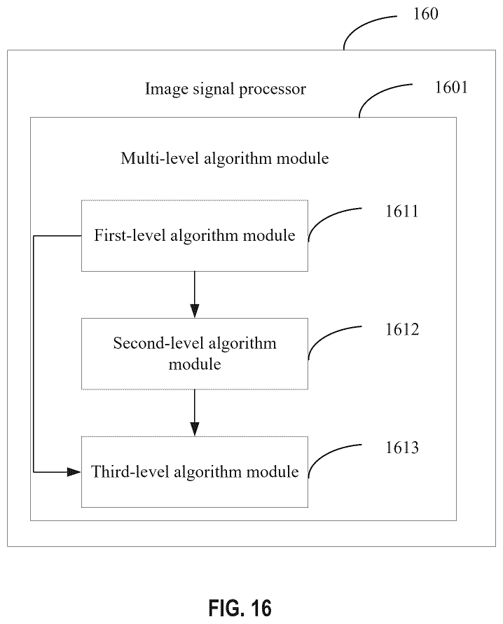

Refer to FIG. 16, which is a schematic diagram of the structure of an image signal processor disclosed in an embodiment of the present application.

As shown in FIG. 16, the image signal processor 160 includes a multi-level algorithm module 1601, and the multi-level algorithm module 1601 includes the first-level algorithm module 1611, the second-level algorithm module 1612, and the third-level algorithm module 1613. The image signal processor applies the point cloud processing method in any of the above embodiments, and the first-level algorithm module 1611, the second-level algorithm module 1612, and the third-level algorithm module 1613 share a buffer space.

The first-level algorithm module 1611 is connected to the second-level algorithm module 1612 and the third-level algorithm module 1613, and is configured to obtain original point cloud data, and start the first-level algorithm to process the original point cloud data to obtain first point cloud data, and buffer the first point cloud data in a buffer space.

In an embodiment, the LiDAR emits outgoing laser beams to the detection area and receives the returned echo laser beams, and obtains the original point cloud data by solving the relative relationship between the outgoing laser beams and the echo laser beams. The first-level algorithm module 1611 starts the first-level algorithm to process each frame of the original point cloud data, obtains several lines of the first point cloud data, and buffers the first point cloud data in a buffer space. The first point cloud data is a general term for point cloud data at different stages, and the point cloud data is a collection of a large amount of point data.

The second-level algorithm module 1612 is connected to the first-level algorithm module 1611 and the third-level algorithm module 1613, and is configured to obtain at least part of the first point cloud data in the buffer space, and perform the second-level algorithm processing on the obtained first point cloud data to obtain second point cloud data.

In an embodiment, the second-level algorithm module 1612 reads the first point cloud data in the buffer space through the first sliding window to obtain the first window data, and performs the second-level algorithm processing on the first window data to obtain the second point cloud data, and inputs the second point cloud data into the third-level algorithm module 1613.

The first window data is composed of a number of point data. The second-level algorithm module 1612 performs the second-level algorithm processing on the first window data, and the result obtained is the calculation result of the center point of the first window data (i.e., the point data currently being calculated).

The third-level algorithm module 1613 is connected to the first-level algorithm module 1611 and the second-level algorithm module 1612, and is configured to simultaneously obtain at least part of the first point cloud data and the second point cloud data, and perform the third-level algorithm processing on the obtained first point cloud data to obtain the third point cloud data, and merge the obtained second point cloud data and the third point cloud data to output the merged result.

In an embodiment, the third-level algorithm module 1613 reads the first point cloud data in the buffer space through the second sliding window to obtain the second window data, and receives the second point cloud data transmitted by the second-level algorithm module 1612 while obtaining the second window data. At the moment, the center point of the second point cloud data and the second window data corresponds to the same point data, thereby after the third-level algorithm module 1613 processes the center point of the second window data to obtain the corresponding third point cloud data, the third point cloud data and the second point cloud data corresponding to the same point data are merged, and the merged result is output. The second window data is composed of a number of point data, and the first window data and the second window data are generally odd numbers of lines.

In some embodiments of the present application, the multi-level algorithm module 1601 also includes the fourth-level algorithm module, and the image signal processor outputs the merged result obtained by the third-level algorithm module 1613 to the fourth-level algorithm module, thereby the fourth-level algorithm module processes the merged result.

The second-level algorithm module 1612 and the third-level algorithm module 1613 process the window data obtained from the buffer space in parallel. When the third-level algorithm module 1613 processes the second window data, it does not rely on the processing result of the second-level algorithm module 1612. However, since the processing results of the second-level algorithm module 1612 and the third-level algorithm module 1613 need to be transmitted to the subsequent algorithm module, it is necessary to merge the second point cloud data and the third point cloud data, and output the merged result to the fourth-level algorithm module. The parallel data stream processing structure saves the delay of waiting for the processing result of the second-level algorithm when calculating the total delay of the multi-level algorithm module 1601.

In an embodiment of the present application, the image signal processor 160 further includes a window taking module, which is configured to control the time for the sliding window to obtain window data from the buffer space according to the delay difference between the second-level algorithm and the third-level algorithm. Where the sliding window includes the first sliding window or the second sliding window, the second-level algorithm module corresponds to the first sliding window, the third-level algorithm module corresponds to the second sliding window, the window data includes the first window data or the second window data, the first sliding window corresponds to the first window data, and the second sliding window corresponds to the second window data.

The second-level algorithm corresponds to the first overall delay, where the first overall delay includes the first window taking delay and the first processing delay. The first window taking delay includes the time for the first sliding window to obtain the first window data from the buffer space, and the first processing delay includes the time for the second-level algorithm to process the first window data to obtain the second point cloud data.

The third-level algorithm corresponds to the second overall delay, where the second overall delay includes the second window taking delay and the second processing delay. The second window taking delay includes the time it takes for the second sliding window to obtain second window data from the buffer space, and the second processing delay includes the time it takes for the third-level algorithm to process the second window data to obtain third point cloud data.

The delay difference between the second-level algorithm and the third-level algorithm is the absolute value of the first overall delay and the second overall delay, where the first overall delay, the second overall delay, and the delay difference between the second-level algorithm and the third-level algorithm can be characterized by the amount of time or by the number of lines of point cloud data.

In an embodiment of the present application, the second-level algorithm module 1612 and the third-level algorithm module 1613 correspond to a window taking module respectively, the second-level algorithm module 1612 corresponds to the first window taking module, and the third-level algorithm module 1613 corresponds to the second window taking module. The first window taking module is configured to control the time when the first sliding window starts to read the first point cloud data from the buffer space, and to perform windowing on the read first point cloud data to obtain the first window data. The second window taking module is configured to control the time when the second sliding window starts to read the first point cloud data from the buffer space, and to perform windowing on the read first point cloud data to obtain the second window data.

In an embodiment of the present application, a window taking module corresponds to each of the second-level algorithm module 1612 and the third-level algorithm module 1613. Each window taking module is configured to control the time for the sliding window to obtain window data from the buffer space according to the delay difference between the second-level algorithm and the third-level algorithm. The third-level algorithm module 1613 simultaneously obtains the first point cloud data and the second point cloud data.

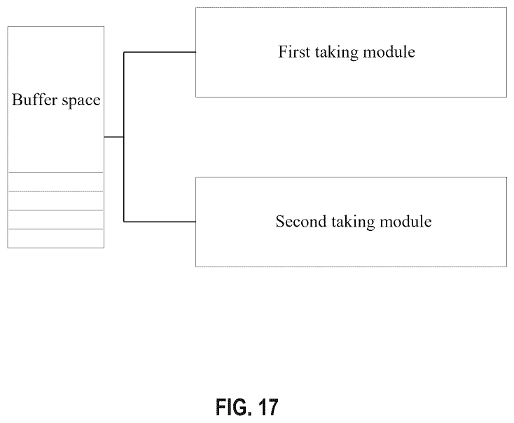

Refer to FIG. 17, which is a schematic diagram of the relationship between a buffer space, the first window taking module and the second window taking module disclosed in an embodiment of the present application.

As shown in FIG. 17, the first window taking module and the second window taking module read the first point cloud data from a buffer space.

In some embodiments of the present application, the buffer space is located outside the multi-level algorithm module 1601. In other embodiments, the buffer space is located inside the first-level algorithm module 1611.

In an embodiment of the present application, the window taking module is a universal module, which maintains its sharing relationship with the external buffer space in an on-demand instantiation manner. That is, by setting the preset line delay parameters to satisfy the requirements of the corresponding algorithm module. The hardware structure and working logic of each sliding window are the same, and the following is an example of a universal sliding window.

The window taking module is configured for: recording the number of lines of the first point cloud data output from the buffer space. When the number of lines of the first point cloud data output from the buffer space is a preset line delay parameter, starting to read the first point cloud data in the buffer space based on the corresponding sliding window, and windowing the read first point cloud data to obtain corresponding window data.

Each window taking module corresponds to a preset line delay parameter. The preset line delay parameter is configured to characterize the delay line number for the sliding window to read the first point cloud data. The preset line delay parameter is calculated according to the delay difference between the second-level algorithm and the third-level algorithm. The preset line delay parameter includes the first line delay parameter or the second line delay parameter. The first window taking module corresponds to the first line delay parameter, and the second window taking module corresponds to the second line delay parameter. The size of the first line delay parameter and the second line delay parameter can be set by those skilled in the art according to actual conditions, and is not limited here.

When the first overall delay is equal to the second overall delay, the first line delay parameter is equal to the second line delay parameter, and the first window taking module and the second window taking module simultaneously control the corresponding sliding window to start obtaining window data from the buffer space. Thereby, the second window data and the second point cloud data are aligned and can be simultaneously input into the third-level algorithm.

When the first overall delay is greater than the second overall delay, the first line delay parameter is less than the second line delay parameter, and the second line delay parameter is the difference between the first overall delay and the second overall delay. At the moment, the second line delay parameter represents the number of lines of the first point cloud data read by the first sliding window. The first window taking module first controls the first sliding window to start obtaining the first window data from the buffer space, and the second window taking module then controls the second sliding window to start obtaining the second window data from the buffer space. Thereby, the second window data and the second point cloud data are aligned and can be simultaneously input into the third-level algorithm.

When the first overall delay is less than the second overall delay, the first line delay parameter is greater than the second line delay parameter, and the first line delay parameter is the difference between the second overall delay and the first overall delay. At the moment, the first line delay parameter has the same meaning as the first line delay representation in step S2322, which is the number of lines of the first point cloud data read by the second sliding window. The second window taking module first controls the second sliding window to start obtaining the second window data from the buffer space, and the first window taking module then controls the first sliding window to start obtaining the first window data from the buffer space. Thereby, the second window data and the second point cloud data are aligned and can be simultaneously input into the third-level algorithm.

In an embodiment, the first overall delay is 2 lines, the second overall delay is 8 lines, and the delay difference between the second-level algorithm and the third-level algorithm is 8−2=6 lines. When the second-line delay parameter is set to 0 line and the first line delay parameter is set to 6 lines, the second window taking module determines that the number of lines of the first point cloud data output from the buffer space is the second line delay parameter, i.e., 0, after identifying the frame start indication signal of the first point cloud data of a frame, and controls the second sliding window to start reading the first point cloud data in the buffer space, and performs windowing on the read first point cloud data to obtain the second window data. The first window taking module records the number of lines of the first point cloud data output from the buffer space. When the number of lines of the first point cloud data output from the buffer space is the first line delay parameter, i.e., 6 lines, the second sliding window reads 6 lines of the first point cloud data in the buffer space, and the first window taking module controls the first sliding window to start reading the first point cloud data in the buffer space, and performs windowing on the read first point cloud data to obtain the first window data.

The first window taking module or the second window taking module slides the window from left to right for each point data contained in a line of first point cloud data in turn, and windowing with each point data as the center to obtain corresponding window data. After the sliding of the window for a line of first point cloud data is completed, the sliding window is controlled to slide the window for the next line of first point cloud data, and windowing with each point data as the center to obtain corresponding window data, until the second-level algorithm or the third-level algorithm corresponding to the sliding window completes processing of all first point cloud data of the current frame.

Furthermore, each time a window is formed to obtain a first window data, the second-level algorithm module 1612 performs second-level algorithm processing on the first window data, that is, performs an operation on the point data M located at the center of the window data, and assigns the obtained result to the point data M to obtain the corresponding second point cloud data, and inputs the second point cloud data into the third-level algorithm module 1613. At the moment, the second window data obtained by the second sliding window group is also synchronously input into the third-level algorithm module 1613, and the second window data is also centered on the point data M. At the moment, the second window data and the second point cloud data are aligned, that is, the second window data and the second point cloud data correspond to the same point data M. Thereby, the third-level algorithm module 1613 processes the second window data to obtain the third point cloud data, and merges the third point cloud data corresponding to the same point data M with the second point cloud data, and outputs the merged result.

In an embodiment of the present application, the window taking module is configured to: record the number of lines of the first point cloud data output from the buffer space; when the number of lines of the first point cloud data output from the buffer space is a preset line delay parameter, the first point cloud data in the buffer space is started to be read based on the corresponding sliding window. The present application can control the time for the sliding window to obtain the corresponding window data from the buffer space, thereby the second point cloud data and the first point cloud data are simultaneously input into the third-level algorithm module. There is no need to set a one-to-one buffer space for the second-level algorithm module and the third-level algorithm module to buffer the first window data and the second window data separately, which can reduce the area of the chip and reduce the delay of waiting for the processing results of the second-level algorithm.

In an embodiment of the present application, according to the number of lines of the sliding window, the process of the window taking module controlling the sliding window to read the first point cloud data in the buffer space is divided into the following two conditions. The working method and process of the first sliding window and the second sliding window are the same, and the following is an example of a general sliding window.

When the number of lines in the sliding window is one line, the window taking module is configured to: take the depth of a buffer space as a modulus, calculate the remainder of the sequence number of the first point cloud data of a line of the current frame, and the remainder is configured as the first line number; and read the first point cloud data corresponding to the first line number in the buffer space.

In an embodiment, the window taking module divides the serial number of each line of the first point cloud data in the first point cloud data of the current frame by the depth of the buffer space to obtain several division results, and takes the remainder for each division result, and adopts the remainder as the corresponding first line number. Every time a first line number is calculated, the window taking module controls the sliding window to read the first point cloud data stored at the location of the first line number in the buffer space, so as to window the line of first point cloud data to obtain corresponding window data.

The depth of the buffer space is greater than or equal to the maximum line value, the maximum line value is the maximum value of the number of lines of the first sliding window, the number of lines of the second sliding window, the first overall delay, and the second overall delay. The first line number is configured to represent the line number corresponding to a line of the first point cloud data in a frame the first point cloud data of in the buffer space.

In an embodiment of the present application, the maximum line value is determined according to the number of lines of the first sliding window, the number of lines of the second sliding window, the first overall delay, and the second overall delay. The depth of the buffer space is greater than or equal to the maximum line value. The present application can make the depth of the buffer space satisfy the simultaneous use of the first window and the second window, and satisfy the requirements of upper and lower docking of every two frames of the first point cloud data.

In an embodiment of the present application, the buffer space supports writing the first point cloud data while the sliding window reads the first point cloud data. When the number of lines in the sliding window is multiple lines, there is a half-window delay line in writing and reading of the first point cloud data. After the buffer space receives the first point cloud data of a frame, the window taking module controls the sliding window to continue sliding down by half-window line until the second-level algorithm or the third-level algorithm corresponding to the sliding window completes processing of all the first point cloud data of the current frame.

In the process of sliding the sliding window downward, when the buffer space receives the first point cloud data of the next frame, the buffer space stores the first point cloud data of the next frame in the next line of the first point cloud data of the last line of the current frame in the buffer space, so that two consecutive frames of first point cloud data can seamlessly cross frames (the frame gap is approximately 0), thereby saving buffer space. However, the method affects the condition where the sliding window obtains window data beyond the upper or lower boundary of the first point cloud data of a frame. That is, it affects the sliding window's acquisition of window data in the first sliding window stage or the third sliding window stage. Therefore, when the number of lines of the sliding window is multiple lines, the window taking module needs to determine the current sliding window stage of the sliding window according to the second line number, and thereby determining whether the read enable signal is valid according to the current sliding window stage of the sliding window.

When the number of lines in the sliding window is multiple lines, the window taking module is configured to: obtain the second line number; take the depth of the buffer space as a modulus, calculating the remainder of the second line number, and the remainder is configured as the first line number; determine the current sliding window stage of the sliding window according to the second line number; and determine whether the read enable signal is valid according to the current sliding window stage of the sliding window. When the read enable signal is valid, determining the third line number according to the depth of the buffer space, the first line number, and the half-window line number; reading the first point cloud data corresponding to the third line number in the buffer space. The sliding window stage includes the first sliding window stage, the second sliding window stage, and the third sliding window stage.

The depth of the buffer space is greater than or equal to the maximum line value. The maximum line value is the maximum value of the number of lines of the first sliding window, the number of lines of the second sliding window, the first overall delay, and the second overall delay. The second line number is the line number of a line of the first point cloud data of the current frame corresponding to the center line of the sliding window. Each sliding window corresponds to a second line number. The absolute value of the difference between the second line number corresponding to the first sliding window and the second line number corresponding to the second sliding window is equal to the delay difference between the second-level algorithm and the third-level algorithm. Each window taking module obtains the second line number corresponding to the sliding window it controls.

In an embodiment, the window taking module divides the second line number by the depth of the buffer space to obtain the division result, takes the remainder of the division result, and adopts the remainder as the first line number. At the moment, the first line number represents the line number corresponding to the center line of the sliding window in the buffer space. The window taking module determines the current sliding window stage of the sliding window according to the relationship between the second line number B, the half-window line number C, and the preset line number (D−1). The half-window line number C is obtained by rounding down half of the number of lines of the sliding window, the preset line number (D−1) is the total number of lines of the first point cloud data of a frame minus one, and D represents the total number of lines of the first point cloud data of a frame.

In an embodiment, when the second line number B is less than the half-window line number C, the center line of the sliding window is in the process of sliding from 0th line to Cth line, and the window taking module determines that the current sliding window stage of the sliding window is the first sliding window stage. When the sliding window is windowed in this stage, the window data of the area above the first point cloud data of the 0th line obtained by the sliding window will be filled with zero.

When the second line number B is greater than or equal to the half-window line number C plus one, and the second line number B is less than or equal to the difference between the preset line number(D−1) and the half-window line number C, the center line of the sliding window is in the process of sliding the window from the (C+1)th line to the (D−1−C)th line, and the window taking module determines that the current sliding window stage of the sliding window is the second sliding window stage. In this stage, the data read by the sliding window are all between the upper and lower boundaries of the first point cloud data of a frame.

When the second line number B is greater than the difference between the preset number line(D−1) and the half-window number line C, and the second line number B is less than or equal to the preset line number(D−1), the center line of the sliding window is in the sliding window process from (D-C)th line to line (D−1)th line, and the window taking module determines that the current sliding window is the third sliding window stage. When the sliding window is windowed in the stage, the window data of the area below the first point cloud data of the last line obtained by the sliding window will be filled with zero.

Furthermore, each line in the sliding window corresponds to a first line number and a third line number. In different sliding window stages, the first line number is determined by a general formula win_line(i). The calculation formula of win_line(i) is as follows:

$$win\_line ( i ) = B - C + i$$

The win_line(i) represents the quantity related to the line number of the ith line in the sliding window, B represents the second line number, C represents the half-window line number, i is the line number of any line in the sliding window, i∈[0,F−1], and F represents the number of lines in the sliding window.

In each sliding window stage, the calculation result of the corresponding win_line(i) is the first line number corresponding to the ith line in the sliding window. In different sliding window stages, whether the read enable signal is valid is determined according to the comparison result of win_line(i).

When the current sliding window is the first sliding window stage, and when the first line number win_line(i) corresponding to the ith line in the sliding window is greater than or equal to zero, the ith line in the sliding window slides between the upper and lower boundaries of the first point cloud data of a frame, and the window taking module determines that the read enable signal corresponding to the third line number E[i] is valid. When the first line number win_line(i) corresponding to the ith line in the sliding window is less than zero, the ith line in the sliding window slides out of the upper boundary of the first point cloud data of the current frame, and the window taking module determines that the read enable signal corresponding to the third line number E[i] is invalid.

When the current sliding window is the second sliding window stage, each line in the sliding window slides between the upper and lower boundaries of the first point cloud data of a frame, and the window taking module determines that the read enable signal corresponding to the third line number E[i] is always valid. The third line number E[i] is the line number corresponding to the ith line in the sliding window in the buffer space.

When the current sliding window is the third sliding window stage, and when the first line number win_line(i) corresponding to the ith line in the sliding window is less than or equal to the preset line number(D−1), the ith line in the sliding window slides between the upper and lower boundaries of the first point cloud data of a frame, and the window taking module determines that the read enable signal corresponding to the third line number E[i] is valid. When the first line number win_line(i) corresponding to the ith line in the sliding window is greater than the preset line number(D−1), the ith line in the sliding window slides out of the lower boundary of the first point cloud data of the current frame, and the window taking module determines that the read enable signal corresponding to the third line number E[i] is invalid.

When the read enable signal corresponding to the third line number E[i] is valid, and when the sum of the depth of the buffer space and the second line number is greater than or equal to the depth of the buffer space, the window module assigns the value of the second line number to the third line number, that is, the value of the third line number E[i] is G−C+i. When the sum of the depth of the buffer space and the second line number is less than the depth of the buffer space, the window taking module determines the third line number as the sum of the second line number and the depth of the buffer space, that is, the value of the third line number E[i] is G−C+i+A.

The second line number is the difference between the first line number G and the half-window line number C plus i, and the first line number G is the remainder obtained by taking the depth of the buffer space as the modulus and calculating the modulus of the second line number.

Furthermore, when the read enable signal corresponding to the third line number is valid, the sliding window reads the first point cloud data corresponding to the third line number in the buffer space, and performs windowing on the read first point cloud data to obtain corresponding window data. When the read enable signal corresponding to the third line number is invalid, the sliding window does not read the first point cloud data corresponding to the third line number.

When the sliding window reads the first point cloud data stored in the buffer space, it can calculate the third line number corresponding to a line index i at each time beat according to the multiple line indexes i in the sliding window. Thereby, after calculating a third line number each time, a line of the first point cloud data is read in the buffer space until all lines in the sliding window obtain the corresponding point data and the window is formed.

In an embodiment of the present application, when the number of lines in the sliding window is one line, the window taking module reads the first point cloud data corresponding to the first line number in the buffer space. Or, when the number of lines in the sliding window is multiple lines, the window taking module reads the first point cloud data corresponding to the third line number in the buffer space. The present application can read the first point cloud data in the buffer space according to the mapping relationship between the center line of the sliding window and the lines in the buffer space.

In an embodiment of the present application, when the number of lines in the sliding window is multiple lines, the window taking module determines whether the read enable signal of the third line number is valid according to the current sliding window stage. When the read enable signal is valid, the first point cloud data corresponding to the third line number is read in the buffer space. The present application can determine whether to read the corresponding first point cloud data according to the line number corresponding to the ith line in the sliding window in the buffer space. Thereby, when the line number corresponds to the upper boundary or lower boundary of the first point cloud data of a frame, the corresponding first point cloud data is not read, thereby avoiding reading invalid data.

In some embodiments of the present application, different delay differences may cause certain data to be accessed simultaneously. Therefore, when the first point cloud data needs to be read in the sliding window, taking into account the reuse of data, the window taking module is also configured to transmit read requests to the buffer space to obtain the corresponding window data, and the external buffer space only responds to the read requests, without distinguishing which window taking module the read request comes from. The working logic of multiple window taking modules is the same, and multiple window taking modules transmit read requests to the buffer space according to the delay requirements. After multiple window taking modules receive the data, each determines whether to transmit the data to the corresponding algorithm module according to the read request. When the chip needs to be compatible with more parallel algorithm modules, it is only necessary to leave some margins in the design and arrange several more window taking modules for easy expansion. The setting method can also be compatible with the variable delay relationship between multiple algorithm modules, and has strong versatility.

The first window taking module is configured to transmit the first read request to the buffer space according to the first delay amount to obtain the first window data, and the second window taking module is configured to transmit the second read request to the buffer space according to the second delay amount to obtain the second window data. The first delay amount represents the delay time for the first window taking module to start transmitting the first read request to the buffer space, and the second delay amount represents the delay time for the second window taking module to start transmitting the second read request to the buffer space. The first delay amount includes the first line delay parameter, and the second delay amount includes the second line delay parameter.

The first read request and the second read request both include a plurality of bits, each bit corresponding to a line in the buffer space, and each bit is configured to represent the value of the read enable signal of the corresponding line in the buffer space. Each third line number corresponds to a bit. For example, when the third line number is a, the read enable signal corresponding to the ath line in the buffer space is the read enable signal corresponding to the third line number.

In some embodiments of the present application, the image signal processor is configured to: perform an OR operation on the bits in the first read request and the second read request; when the result of the OR operation is a preset value, read the first point cloud data stored in the corresponding line in the buffer space, and transmit the read first point cloud data to the first sliding window and the second sliding window respectively.

In an embodiment, when the window taking module determines that the read enable signal corresponding to a third line number is invalid, the corresponding bit in the read request is marked as 0, and when the read enable signal corresponding to a third line number is determined to be valid, the corresponding bit in the read request is marked as 1. Furthermore, the image signal processor performs an OR operation on the bits of the same line in the corresponding buffer space in the first read request and the second read request to obtain the result of the OR operation corresponding to the line, and when the result of the OR operation corresponding to any line is a preset value. For example, when the result of the OR operation is 1, the first point cloud data stored in the line of the buffer space is read, and the read first point cloud data is transmitted to the first sliding window and the second sliding window respectively. When the result of the OR operation corresponding to any line is not a preset value, for example, when the result of the OR operation is 0, the first point cloud data stored in the line of the buffer space is not read.

In an embodiment of the present application, performing an OR operation on the bits in the first read request and the second read request, when the result of the OR operation is a preset value, the first point cloud data stored in the corresponding line in the buffer space is read, and the read first point cloud data is transmitted to the first sliding window and the second sliding window respectively. When there is data overlap in the first point cloud data read by the first sliding window and the second sliding window, the present application can transmit the same line of first point cloud data to be read to the first sliding window and the second sliding window respectively, thereby realizing that the first sliding window and the second sliding window share a buffer space.

In some embodiments of the present application, when the value of a bit in a read request (the first read request or the second read request) is 0, and the first point cloud data stored in the line in the buffer space corresponding to the bit is transmitted to the first sliding window and the second sliding window respectively, the sliding window corresponding to the read request does not perform windowing or transmit it to the corresponding algorithm module for windowing after obtaining the first point cloud data in the line.

In an embodiment of the present application, after reading the first point cloud data corresponding to the third line number from the buffer space, the window taking module is also configured to: when the center line of the sliding window corresponds to the 0th line in the buffer space, fill the window data corresponding to the area of the sliding window above the 0th line with zero; store each line of the read first point cloud data in the sliding window in sequence, and obtain a window data each time the number of lines of the first point cloud data stored in the sliding window reaches the number of lines of the sliding window; after the buffer space completes storing the last line of the first point cloud data of a frame, while the sliding window slides downward, fill the window data corresponding to the area of the sliding window below the last line of the first point cloud data of a frame with zero, until the second-level algorithm or the third-level algorithm corresponding to the sliding window completes processing of all first point cloud data of the current frame.

In some embodiments of the present application, the image signal processor directly stores the original point cloud data in the buffer space, and the first-level algorithm module 1611 is configured to process the original point cloud data in the buffer space to obtain the first point cloud data. The first-level algorithm module 1611 reads the original point cloud data in the buffer space through a sliding window to obtain the corresponding window data, and then processes the window data to obtain the first point cloud data.

When the first-level algorithm module 1611 needs to obtain window data from the buffer space, the first-level algorithm module 1611 corresponds to a window taking module, which has a similar function to the first window taking module or the second window taking module mentioned above, which will not be repeated here.

In some embodiments of the present application, the number of the first-level algorithm module 1611, the second-level algorithm module 1612, and the third-level algorithm module 1613 in the multi-level algorithm module 1601 can be multiple. In addition, the multi-level algorithm module 1601 can further include multiple algorithm modules. For example, the multi-level algorithm module includes a fourth algorithm module, a fifth algorithm module, and other algorithm modules (not shown in FIG. 16). As long as the startup calculation of the next level algorithm module does not rely on the processing result of the previous level algorithm module, the two level algorithm modules can perform algorithm processing in parallel and share a buffer space, thereby improving the processing efficiency of the image signal processor.

In an embodiment of the present application, an image signal processor is provided, which applies or executes the point cloud processing method mentioned in the above embodiment. The image signal processor includes a multi-level algorithm module, and the multi-level algorithm module includes a first-level algorithm module, a second-level algorithm module, and a third-level algorithm module, where the first-level algorithm module, the second-level algorithm module, and the third-level algorithm module share a buffer space. Where the first-level algorithm module is connected to the second-level algorithm module and the third-level algorithm module, and is configured to obtain original point cloud data, and start the first-level algorithm to process the original point cloud data to obtain first point cloud data, and the first point cloud data is buffered in a buffer space. The second-level algorithm module is connected to the first-level algorithm module and the third-level algorithm module, and is configured to obtain at least part of the first point cloud data in the buffer space, and perform the second-level algorithm processing on the obtained first point cloud data to obtain the second point cloud data. The third-level algorithm module is connected to the first-level algorithm module and the second-level algorithm module, and is configured to simultaneously obtain at least part of the first point cloud data and the second point cloud data, and perform the third-level algorithm processing on the obtained first point cloud data to obtain the third point cloud data, and merge the obtained second point cloud data and the third point cloud data to output the merged result.

On the one hand, since the first-level algorithm module, the second-level algorithm module, and the third-level algorithm module share a buffer space, the present application only needs to set up one buffer space, and there is no need to set up a buffer space for each level of algorithm module, which can reduce the area of the chip and thus reduce the power consumption of the chip. On the other hand, by simultaneously obtaining at least part of the first point cloud data and the second point cloud data through the third-level algorithm module, performing the third-level algorithm processing on the obtained first point cloud data to obtain the third point cloud data, and merging the obtained second point cloud data and the third point cloud data, the present application can reduce the delay of waiting for the processing results of the second-level algorithm, thereby reducing the overall delay of the image signal processor.

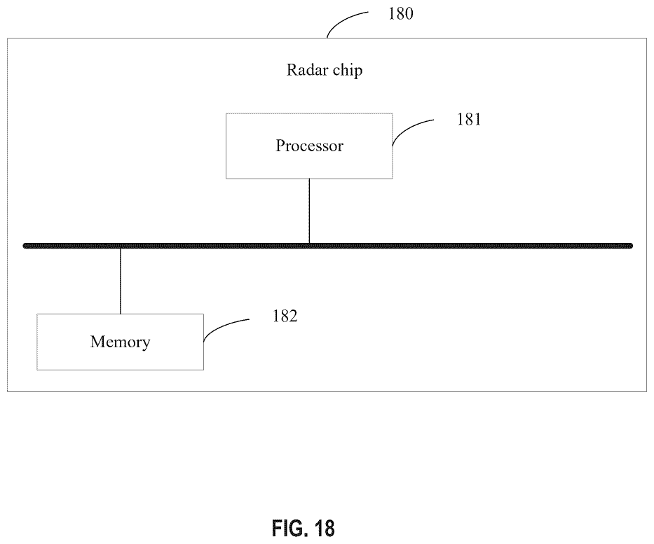

Refer to FIG. 18, which is a schematic diagram of the structure of a radar chip disclosed in an embodiment of the present application.

As shown in FIG. 18, the radar chip 180 includes one or more processors 181 and a memory 182. FIG. 18 takes one processor 181 as an example.

The processor 181 and the memory 182 may be connected through a bus or other means. FIG. 18 takes the connection through a bus as an example.

The processor 181 is configured to provide computation and control functions to control the radar chip 180 to perform corresponding tasks. For example, the processor 181 controls the radar chip 180 to perform the point cloud processing method in any of the above method embodiments.

The processor 181 may be a general purpose processor, including a central processing unit (CPU), a network processor (NP), a hardware chip, or any combination of them. It can also be a digital signal processor (DSP), an application specific integrated circuit (ASIC), a programmable logic device (PLD), or a combination of them. The PLD may be a complex programmable logic device (CPLD), a field-programmable gate array (FPGA), a generic array logic (GAL), or any combination of them.

The memory 182 is a non-transitory computer-readable storage medium, which can be figured to store non-transitory software programs, non-transitory computer executable programs and modules, such as program instructions/modules corresponding to the point cloud processing method in some embodiments of the present application. The processor 181 can implement the point cloud processing method in any of the above method embodiments by running the non-transitory software programs, instructions and modules stored in the memory 182. The memory 182 may include a volatile memory (VM), such as a random access memory (RAM). The memory 182 may also include a non-volatile memory (NVM), such as a read-only memory (ROM), a flash memory, a hard disk drive (HDD), a solid-state drive (SSD), or other non-transitory solid-state storage devices. The memory 182 may also include a combination of the above types of memories.

The memory 182 may include a high-speed random access memory, and may also include a non-volatile memory, such as at least one disk storage device, a flash memory device, or other non-volatile solid-state storage devices. In some embodiments, the memory 182 may include a memory remotely arranged relative to the processor 181, and these remote memories may be connected to the processor 181 through a network. Examples of the above-mentioned network include, but are not limited to, the Internet, an intranet, a local area network, a mobile communication network, and combinations of them.

One or more modules are stored in the memory 182, and when executed by one or more processors 1011, the point cloud processing method in any of the above method embodiments is executed, for example, the various steps shown in FIG. 3 described above are executed.

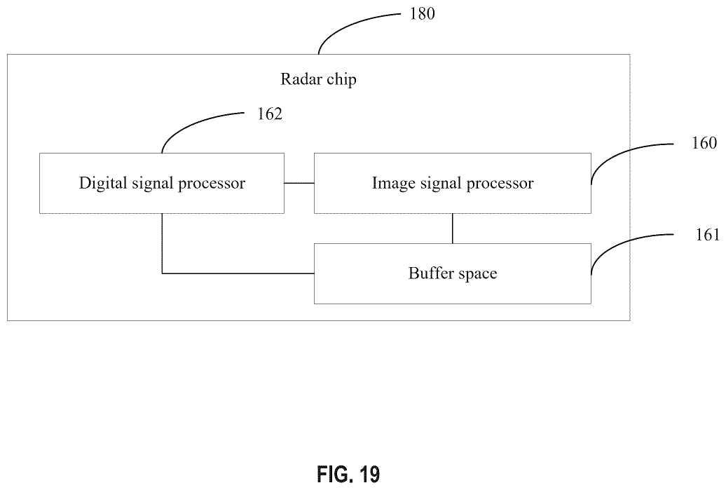

Refer to FIG. 19, which is a schematic diagram of the structure of a radar chip disclosed in an embodiment of the present application.

As shown in FIG. 19, the radar chip 180 includes an image signal processor 160, a buffer space 161, and a digital signal processor 162.

In some embodiments of the present application, the digital signal processor 162 is configured to receive the electrical signal, convert the electrical signal into the digital signal, and process the digital signal to obtain original point cloud data.

In some embodiments of the present application, the image signal processor 160 is connected to the digital signal processor 162, and the image signal processor 160 is configured to receive the original point cloud data transmitted by the digital signal processor 162 and execute the point cloud processing method mentioned in the above embodiments. The specific structure of the image signal processor 160 is shown in FIG. 16, and the relevant content can refer to the above-mentioned content, which will not be repeated here.

In some embodiments of the present application, the buffer space 161 is connected to the digital signal processor 162 and the image signal processor 160 respectively, and the buffer space is configured to buffer the first point cloud data processed by the image signal processor 160.

In an embodiment of the present application, a radar chip is provided, and the radar chip includes the image signal processor in the above embodiments. The present application can improve the processing efficiency of the radar chip for raw point cloud data by reducing the overall delay of the image signal processor, and can reduce the area of the radar chip by setting only one buffer space in the image signal processor, thereby reducing the power consumption of the radar chip.

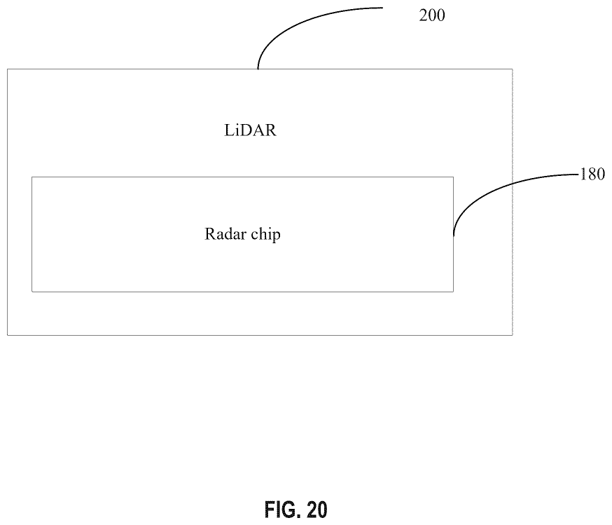

Refer to FIG. 20, which is a schematic diagram of the structure of a LiDAR disclosed in an embodiment of the present application.

As shown in FIG. 20, the LiDAR 200 includes a radar chip 180. The radar chip 180 is the radar chip mentioned in the above embodiments, which will not be repeated here.

In an embodiment of the present application, a LiDAR is provided, which includes the radar chip in the above embodiments. The present application can improve the processing efficiency of the LiDAR for point cloud data by improving the processing efficiency of the radar chip for raw point cloud data, and reduce the power consumption of the LiDAR by reducing the area and power consumption of the radar chip.

In an embodiment of the present application, a non-volatile computer storage medium is provided, which stores computer executable instructions, and the computer executable instructions are executed by one or more processors. For example, the one or more processors can execute the point cloud processing method in any of the above method embodiments, for example, execute the various steps described above.

The above-described device or equipment embodiments are merely illustrative, and the unit modules described as separate components may or may not be physically separated, and the components displayed as module units may or may not be physical units. That is, they may be located in one place, or may be distributed on multiple network module units. Some or all of the modules may be selected according to actual needs to achieve the purpose of the present embodiment.

Through the description of the above implementation methods, those skilled in the art can clearly understand that each implementation method can be implemented by means of software plus a general hardware platform, and by hardware. Based on this understanding, the above technical solution can be essentially, or in other words, the part that contributes to the relevant technology can be, embodied in the form of a software product. The computer software product can be stored in a computer-readable storage medium, such as ROM/RAM, a disk, an optical disk, etc., and may include a number of instructions to enable a computer device (which can be a personal computer, a server, or a network device, etc.) to execute aforementioned methods.

Finally, it should be noted that the above embodiments are only used to illustrate the technical solutions of the present application, rather than to limit them. Under the concept of the present application, the technical features in the above embodiments or different embodiments can also be combined, the steps can be implemented in any order, and there are many other changes in different aspects of the present application as above, which are not provided in detail for the sake of simplicity. Although the present application has been described in detail with reference to the aforementioned embodiments, a person of ordinary skill in the art should understand that the technical solutions described in the aforementioned embodiments can still be modified, or some of the technical features can be replaced by equivalents. These modifications or replacements do not deviate the essence of the corresponding technical solutions from the scope of the technical solutions of the embodiments of the present application.

What is claimed is:

1. A point cloud processing method, applied to an image signal processor, wherein the image signal processor is configured to run multi-level algorithms for point cloud processing, and the multi-level algorithms include a first-level algorithm, a second-level algorithm, and a third-level algorithm, and wherein the first-level algorithm, the second-level algorithm, and the third-level algorithm share a buffer space, the point cloud processing method comprising:
obtaining original point cloud data;
starting the first-level algorithm to process the original point cloud data to obtain first point cloud data, and buffering the first point cloud data in a buffer space; and
according to a delay difference between the second-level algorithm and the third-level algorithm, simultaneously inputting at least part of the first point cloud data and second point cloud data into the third-level algorithm, wherein the second-level algorithm is configured to process the obtained first point cloud data to obtain the second point cloud data, and the third-level algorithm is configured to process the obtained first point cloud data to obtain third point cloud data, and merge the second point cloud data and the third point cloud data to output the merged result.

2. The point cloud processing method according to claim 1, wherein:
the second-level algorithm and the third-level algorithm both read the first point cloud data in the buffer space through a sliding window to obtain corresponding window data, wherein the second-level algorithm corresponds to the first sliding window, the third-level algorithm corresponds to the second sliding window, the window data includes a first window data or a second window data, the first sliding window corresponds to the first window data, and the second sliding window corresponds to the second window data;
the second-level algorithm corresponds to a first overall delay, wherein the first overall delay includes a first windowing delay and a first processing delay, wherein the first windowing delay includes time for the first sliding window to obtain the first window data from the buffer space, and the first processing delay includes time for the second-level algorithm to process the first window data to obtain the second point cloud data; and
the third-level algorithm corresponds to a second overall delay, wherein the second overall delay includes a second windowing delay and a second processing delay, the second windowing delay includes time for the second sliding window to obtain the second window data from the buffer space, and the second processing delay includes time for the third-level algorithm to process the second window data to obtain the third point cloud data.

3. The point cloud processing method according to claim 2, wherein:
simultaneously input the first point cloud data and the second point cloud data into the third-level algorithm comprising:
calculating the delay difference between the second-level algorithm and the third-level algorithm according to a first overall delay and a second overall delay; and
controlling the time when the first sliding window starts to obtain the first window data from the buffer space and the time when the second sliding window starts to obtain the second window data from the buffer space based on the delay difference, thereby the second point cloud data and the second window data being simultaneously input into the third-level algorithm.

4. The point cloud processing method according to claim 3, wherein:
the first overall delay is smaller than the second overall delay;
controlling the time when the first sliding window starts to obtain the first window data from the buffer space and the time when the second sliding window starts to obtain the second window data from the buffer space based on the delay difference comprising:
reading the first point cloud data in the buffer space based on the second sliding window, and windowing on the read first point cloud data to obtain the second window data;
recording a first line delay, wherein the first line delay is configured to characterize a number of lines of the first point cloud data read by the second sliding window; and
when the first line delay is equal to the delay difference, reading the first point cloud data in the buffer space based on the first sliding window, and windowing on the read first point cloud data to obtain the first window data.

5. The point cloud processing method according to claim 2, wherein:
when the number of lines of the sliding window is one line, reading the first point cloud data in the buffer space through the sliding window, comprising:
taking a depth of the buffer space as a modulus, calculating a remainder of a sequence number of the first point cloud data of a line of a current frame, and the remainder is configured as a first line number; and
reading the first point cloud data corresponding to the first line number in the buffer space.

6. The point cloud processing method according to claim 2, wherein:
when the number of lines of the sliding window is multiple lines, the process of reading the first point cloud data by the sliding window includes a first sliding window stage, a second sliding window stage, and a third sliding window stage, and reading the first point cloud data in the buffer space through the sliding window, comprising:
obtaining a second line number, wherein the second line number is a line number of the first point cloud data of a line of a current frame corresponding to the center line of the sliding window;
taking a depth of the buffer space as a modulus, calculating a remainder of the second line number, and the remainder is configured as the first line number;
determining a current sliding window stage according to the second line number;
determining whether a read enable signal is valid according to the current sliding window stage;
when the read enable signal is valid, determining a third line number based on the depth of the buffer space, the first line number, and a half-window line number, wherein the third line number is a line number corresponding to an ith line in the sliding window in the buffer space, and the half-window line number is obtained by rounding down half of the number of lines in the sliding window; and
reading the first point cloud data corresponding to the third line number in the buffer space.

7. The point cloud processing method according to claim 6, wherein:
determining the sliding window stage of the sliding window according to the second line number, comprising:
when the second line number is less than the half-window line number, determining that the current sliding window stage of the sliding window is the first sliding window stage;
when the second line number is greater than or equal to the half-window line number plus one, and the second line number is less than or equal to the difference between a preset line number and the half-window line number, determining that the current sliding window stage of the sliding window is the second sliding window stage; and
when the second line number is greater than the difference between a preset number of lines and the half-window line number, and the second line number is less than or equal to the preset number of lines, determining that the current sliding window stage of the sliding window is the third sliding window stage,
wherein the preset number of lines is a total number of lines of the first point cloud data of a frame minus one.

8. The point cloud processing method according to claim 6, wherein:
determining whether the read enable signal is valid according to the current sliding window stage of the sliding window, comprising:
in the first sliding window stage, when the first line number is greater than or equal to zero, determining the read enable signal is valid, and when the first line number is less than zero, determining the read enable signal is invalid, wherein the first line number is the difference between the second line number and the half-window line number plus i, and i is the line number of any line in the sliding window in the sliding window;
in the second sliding window stage, determining the read enable signal is valid; and
in the third sliding window stage, when the first line number is less than or equal to a preset line number, determining the read enable signal is valid; and when the first line number is greater than the preset line number, determining the read enable signal invalid, wherein the preset line number is a total number of lines of first point cloud data of a frame minus one.

9. The point cloud processing method according to claim 8, wherein:
the first sliding window corresponds to a first read request, the second sliding window corresponds to a second read request, the first read request and the second read request each include a plurality of bits, the bits correspond one-to-one to lines in the buffer space, and each of the bits is configured to represent a value of a read enable signal of a corresponding line in the buffer space;
the point cloud processing method further comprising:
performing OR operation on bits in the first read request and the second read request; and
when a result of the OR operation is a preset value, reading the first point cloud data stored in the corresponding line in the buffer space, and transmitting the read first point cloud data to the first sliding window and the second sliding window respectively.

10. The point cloud processing method according to claim 6, wherein:
determining the third line number based on the depth of the buffer space, the first line number, and the half-window line number, comprising:
when a sum of the depth of the buffer space and the second line number is greater than or equal to the depth of the buffer space, assigning a value of the second line number to the third line number; and
when the sum of the depth of the buffer space and the second line number is less than the depth of the buffer space, determining the third line number to be the sum of the second line number and the depth of the buffer space,
wherein the second line number is the difference between the first line number and the half-window line number plus i, where i is the line number of any line in the sliding window.

11. The point cloud processing method according to claim 4, wherein:
windowing on the read first point cloud data comprising:
when the center line of the sliding window corresponds to a 0th line in the buffer space, the window data corresponding to an area of the sliding window above the 0th line is filled with zeros;
the first point cloud data of the current line read is sequentially stored in the sliding window, and a window of data is obtained when the number of lines of the first point cloud data stored in the sliding window reaches the number of lines of the sliding window; and
after the buffer space completes storing the last line of the first point cloud data of a frame, in the process of the sliding window sliding downward, the window data corresponding to the area of the sliding window below the last line of the first point cloud data of a frame is filled with zeros until the second-level algorithm or the third-level algorithm corresponding to the sliding window completes processing of all the first point cloud data of a current frame.

12. The point cloud processing method according to claim 6, comprising:
when the sliding window slides downward, when the buffer space receives the first point cloud data of the next frame, the first point cloud data of the next frame is stored in the next line of the last line of the first point cloud data of a current frame in the buffer space.

13. An image signal processor, comprising a multi-level algorithm module, wherein the multi-level algorithm module includes a first-level algorithm module, a second-level algorithm module, and a third-level algorithm module, wherein:
the first-level algorithm module, the second-level algorithm module, and the third-level algorithm module share a buffer space,
the first-level algorithm module is connected to the second-level algorithm module and the third-level algorithm module, and is configured to obtain original point cloud data, and start the first-level algorithm to process the original point cloud data to obtain first point cloud data, and buffer the first point cloud data in a buffer space;
the second-level algorithm module is connected to the first-level algorithm module and the third-level algorithm module, and is configured to obtain at least part of the first point cloud data in the buffer space, and start the second-level algorithm to process the obtained first point cloud data to obtain second point cloud data; and
the third-level algorithm module is connected the first-level algorithm module and the second-level algorithm module, and is configured to simultaneously obtain at least part of the first point cloud data and the second point cloud data, and start the third-level algorithm to process the obtained first point cloud data to obtain third point cloud data, and merge the obtained second point cloud data and the third point cloud data to output the merged result.

14. The image signal processor according to claim 13, wherein:
the image signal processor further includes a window taking module, and the window taking module is configured to control the time for the sliding window to obtain the window data from the buffer space according to the delay difference between the second-level algorithm and the third-level algorithm,
wherein the second-level algorithm module and the third-level algorithm module respectively correspond to the window taking module.

15. The image signal processor according to claim 14, wherein the window taking module is configured to:
record the number of lines of the first point cloud data output from the buffer space;
when the number of lines of the first point cloud data output from the buffer space is a preset line delay parameter, start to read the first point cloud data in the buffer space based on the corresponding sliding window, and window on the read first point cloud data to obtain corresponding window data; and
when each window taking module corresponds to a preset line delay parameter, calculate the preset line delay parameter according to the delay difference between the second-level algorithm and the third-level algorithm.

16. The image signal processor according to claim 14, wherein:
the sliding window includes a first sliding window or a second sliding window, the second-level algorithm module corresponds to the first sliding window, and the third-level algorithm module corresponds to the second sliding window;
the window data includes first window data or second window data, the first sliding window corresponds to the first window data, and the second sliding window corresponds to the second window data;
the depth of the buffer space is greater than or equal to the maximum line number, which is the maximum value among the number of lines in the first sliding window, the number of lines in the second sliding window, the first overall delay, and the second overall delay;
the first overall delay includes a first window taking delay and a first processing delay, wherein the first window taking delay includes time for the first sliding window to obtain the first window data from the buffer space, and the first processing delay includes time for the second-level algorithm module to process the first window data to obtain the second point cloud data; and
wherein the second overall delay includes a second window taking delay and a second processing delay, and the second window taking delay includes time for the second sliding window to obtain the second window data from the buffer space, and the second processing delay includes time for the third-level algorithm module to process the second window data to obtain the third point cloud data.

17. The image signal processor according to claim 16, wherein when the number of lines in the sliding window is one line, the window taking module is configured to:
take the depth of the buffer space as a modulus, calculate the remainder of the sequence number of the first point cloud data of a line of the current frame, and take the remainder as the first line number; and
read the first point cloud data corresponding to the first line number in the buffer space; or
when the number of lines of the sliding window is multiple lines, the window taking module is configured to:
obtain a second line number, wherein the second line number is a line number of a line of first point cloud data of the current frame corresponding to the center line of the sliding window;
determine the current sliding window stage according to the second line number, wherein the sliding window stage includes a first sliding window stage, a second sliding window stage, and a third sliding window stage; and
determine whether the read enable signal is valid according to the current sliding window stage of the sliding window; and
when the read enable signal is valid, determine a third line number based on the depth of the buffer space, the first line number, and the half-window line number,
wherein the third line number is a line number corresponding to the ith line in the sliding window in the buffer space, and the half-window line number is obtained by rounding down half of the number of lines in the sliding window; and the first point cloud data corresponding to the third line number is read in the buffer space.

18. The image signal processor according to claim 17, wherein:
the window taking module includes a first window taking module and a second window taking module, the first window taking module is configured to transmit a first read request to the buffer space to obtain the first window data, and the second window taking module is configured to transmit a second read request to the buffer space to obtain the second window data; and
the first read request and the second read request each include a plurality of bits, the bits correspond one-to-one to lines in the buffer space, and each of the bits is configured to represent a value of a read enable signal of a corresponding line in the buffer space; and
the image signal processor is configured to:
perform OR operation on bits in the first read request and the second read request; and
when a result of the OR operation is a preset value, read first point cloud data stored in the corresponding line in the buffer space, and transmit the read first point cloud data to the first sliding window and the second sliding window respectively.

19. The image signal processor according to claim 14, wherein the window taking module is further configured to:
when the center line of the sliding window corresponds to the 0th line in the buffer space, fill the window data corresponding to the area above the 0th line of the sliding window with zeros;
when each line of the first point cloud data read is sequentially stored in the sliding window and when the number of lines of the first point cloud data stored in the sliding window reaches the number of lines of the sliding window, obtain a window data; and
after the buffer space completes storing the last line of a frame of first point cloud data, in the process of the sliding window sliding downward, fill with zeros for the window data corresponding to the area of the sliding window below the last line of a frame of first point cloud data until the second-level algorithm or the third-level algorithm completes processing of all first point cloud data of the current frame.

20. A radar chip, comprising:
a processor and a memory, wherein the processor is configured to execute an executable program code in the memory, and when the executable program code is executed, the processor executes instructions of a point cloud processing method applied to an image signal processor, wherein the image signal processor includes a multi-level algorithm module, the multi-level algorithm module includes a first-level algorithm module, a second-level algorithm module, and a third-level algorithm module, wherein:
the first-level algorithm module, the second-level algorithm module, and the third-level algorithm module share a buffer space;
the first-level algorithm module is connected to the second-level algorithm module and the third-level algorithm module, and is configured to obtain original point cloud data, and start the first-level algorithm to process the original point cloud data to obtain the first point cloud data, and buffer the first point cloud data in a buffer space;
the second-level algorithm module is connected to the first-level algorithm module and the third-level algorithm module, and is configured to obtain at least part of the first point cloud data in the buffer space, and start the second-level algorithm to process the obtained first point cloud data to obtain second point cloud data; and
the third-level algorithm module is connected the first-level algorithm module and the second-level algorithm module, and is configured to simultaneously obtain at least part of the first point cloud data and the second point cloud data, and start the third-level algorithm to process the obtained first point cloud data to obtain third point cloud data, and merge the obtained second point cloud data and the third point cloud data to output the merged result.
